(19) United States
(12) Patent Application Publication
(10) Pub. No.: US 2012/0041193 A1
(43) Pub. Date: Feb. 16, 2012

(54) SUBSTITUTED INTERNAL VINYL-BORONIC ACIDS AND BORONIC ACID DERIVATIVES

(75) Inventors: Shivanand K. Math, North Logan, UT (US); Homayoun H. Mokri, North Logan, UT (US); James B. LaMunyon, Richmond, UT (US); Dustin R. Cefalo, Hyrum, UT (US); Charles A. Testa, Salt Lake City, UT (US)

(73) Assignee: Frontier Scientific, Inc., Logan, UT (US)

(21) Appl. No.: 13/207,327

(22) Filed: Aug. 10, 2011

Related U.S. Application Data
(60) Provisional application No. 61/373,196, filed on Aug. 12, 2010.

(51) Int. Cl. C07F 5/02

(52) U.S. Cl. 540/541; 548/405; 546/13; 544/56; 544/229; 544/69; 564/8; 556/402

(57) ABSTRACT

Disclosed herein are vinyl-bromides, vinyl-boronic acids and vinyl-boronic acid derivatives useful as synthetic intermediates for the preparation of therapeutic agents. Also disclosed are methods of synthesis of vinyl-bromides, vinyl-boronic acids and vinyl-boronic acid derivatives.

### RELATED APPLICATION

This application claims the benefit of U.S. Provisional Application No. 61/373,196, filed Aug. 12, 2010, the disclosure of which is incorporated herein by reference in its entirety.

### BACKGROUND

Boronic acid and boronic acid derivatives have long been used in synthetic organic chemistry to make C—C, C—O, C—N, and C—S bonds via cross-coupling reactions. This approach has shown to be very valuable for a synthetic chemist as a key step in the synthesis of more complex molecules that have applications in a wide range of scientific disciplines.

Substituted internal vinyl-boronic acids and boronic acid derivatives, are a particular class of compounds that possess a boronic acid or boronic acid derivatives on an internal carbon of a vinyl-moiety in functionalized terminal alkenes. Typical boronic acid derivatives include, but are not limited to, potassium trifluoroborates, lithium trialkylborates, lithium trihydroxyborates, and boronic acid esters derived from pinacol, neopentylglycol, 4-methyl-2,4-pentanediol, ethylene glycol, and propylene glycol.

Substituted internal vinyl-boronic acids and boronic acid derivatives can have many applications in disciplines such as medicinal chemistry and material science. In medicinal chemistry, these building blocks can be used to synthesize products useful to discover/develop a drug-like molecule/drug candidate.

Substituted internal vinyl-boronic acids and boronic acid derivative building blocks will also be equally valuable in olefin metathesis to generate complex C═C bonds in molecules. Olefin metathesis reactions are cleaner, less expensive, and the resultant products have applications in polymers, pesticides, fine chemicals, and as pharmaceutical intermediates.

In general, the olefin moiety in a molecule is useful as a point of synthetic manipulation. For example, the olefin moiety may be functionalized by hydroboration, reduction, epoxidation, cyclopropanation, dihydroxylation, ozonolysis and other reactions well known in the art.

There are few internal vinyl-bromides and internal vinyl-boronates with substitution at the allylic center mentioned in the literature (Organ, M. E. et al., J. Comb. Chem. 2001, 3, 64-67, and Renaud, J. et al. J. Am. Chem. Soc. 1998, 120, 7995-7996, incorporated herein in their entireties).

### SUMMARY

Some embodiments include a compound having the formula (I):

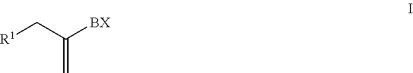

wherein:

R¹ is R^{1a}O—, R^{1a}S—, R^{1b}R^{1c}N—, or R^{1d};

R^{1a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};

R^{1aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{2a} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};

each R^{2aa} is separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzene sulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc}, said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃,

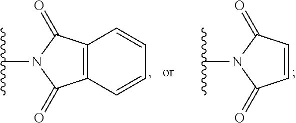

R^{1bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{1d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};

each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and

BX is —BF₃M¹, —B(OH)₂, —B(OC₁₋₆ alkyl)₃M¹, or B(OH)₃M¹; and M¹ is a metal or metal salt. In some embodiments, M¹ is ⁺Na, ⁺K, ^{+Li,} ⁺MgX¹, ⁺ZnX¹, or ⁺CuLi; and X¹ is halo.

Some embodiments include a compound having the formula (I):

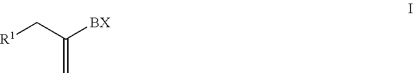

wherein:

R^{1a} is R^{1a}O—, R^{1a}S—, R^{1b}R^{1c}N—, or R^{1d};

R^{1a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};

R^{1aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{2a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};

each R^{2aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc} said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃,

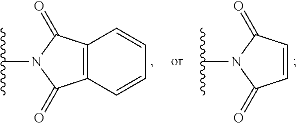

R^{1bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{1d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};

each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and

BX is a boronic ester, with the proviso the compound having the formula (I) is not

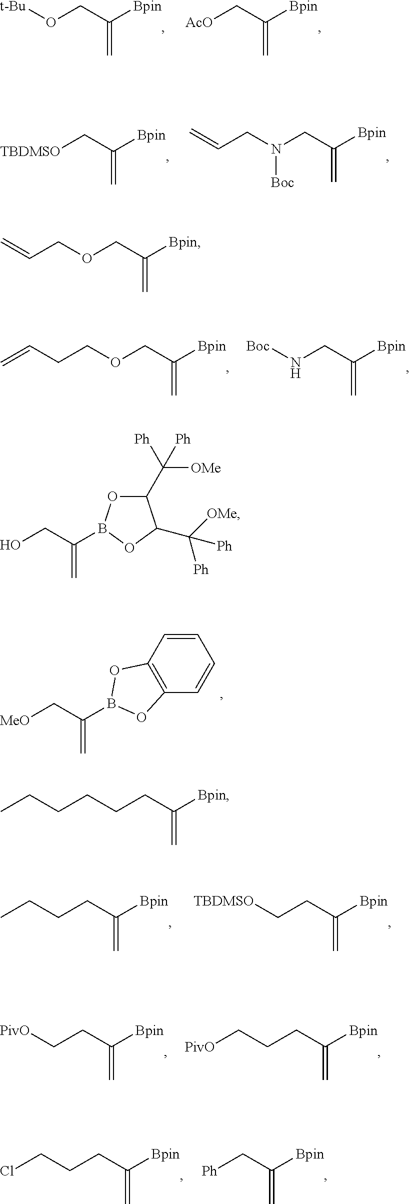

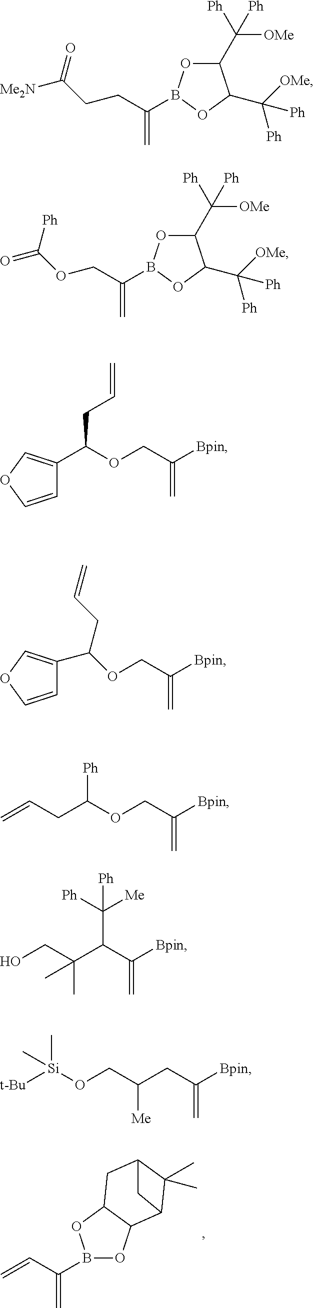

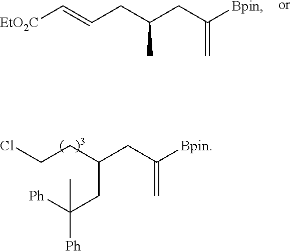

Some embodiments include a compound having the formula (II):

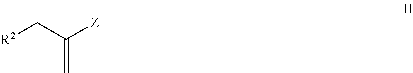

wherein:

R² is R^{10a}O—, R^{10a}S—, R^{10b}R^{10c}N—, or R^{10d};

R^{10a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl or R^{10aa}, each optionally substituted with one or more R^{20a};

R^{10aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{20a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{20aa};

each R^{20aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{10b} and R^{10c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl or R^{10bb}, each optionally substituted with one or more R^{20bc}, R^{10b}R^{10c}N— is a non-aromatic heterocycle optionally substituted with one or more R^{20bc} said non-aromatic heterocycle covalently bonded to the parent molecule through a —N— linkage, or R^{10b}R^{10c}N— is a C₁-C₂₀ alkylideneamino optionally substituted with one or more R^{20bc}, said C₁-C₂₀ alkylideneamino covalently bonded to the parent molecule through a —N— linkage, or R^{10b}R^{10c}N— is —N₃,

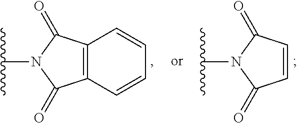

R^{10bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{20bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{10d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{20d};

each R^{20d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and Z is halo.

Some embodiments include a method of chemical synthesis comprising:

reacting a compound of formula (III):

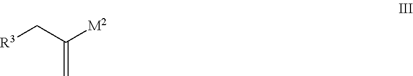

with an alkylborate to provide a compound of formula (IV):

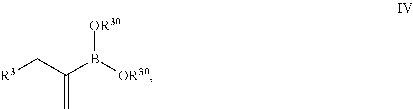

wherein

R³ is R^{30a}O—, R^{30a}S—, R^{30b}R^{30c}N—, or R^{30d};

R^{30a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30aa}, each optionally substituted with one or more R^{40a};

R^{30aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{40a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{40aa};

each R^{40aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{30b} and R^{30c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30bb}, each optionally substituted with one or more R^{40bc}, or R³⁰R^{30c}N— is a non-aromatic heterocycle optionally substituted with one or more R^{40bc} said non-aromatic heterocycle covalently bonded to the parent molecule through a —N— linkage, or R^{30b}R^{30c}N— is a C₁-C₂₀ alkylideneamino optionally substituted with one or more R^{40bc}, said C₁-C₂₀ alkylideneamino covalently bonded to the parent molecule through a —N— linkage, or R^{30b}R^{30c}N— is —N₃,

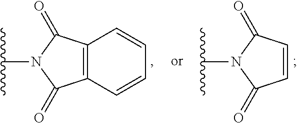

R^{30bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{40bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{30d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{40d};
each R^{40d} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; M² is ⁺Li, ⁺ZnX², ⁺MgX², or ⁺CuLi;

X² is halo; and

each R³⁰ is separately C₁₋₂₀ alkyl or C₃₋₁₀ cycloalkyl, or —B(OR³⁰)₂ is

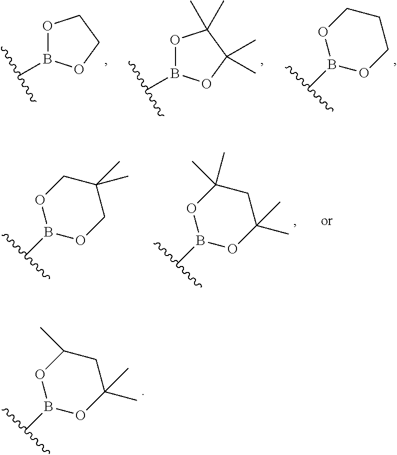

In some embodiments, the alkylborate can be

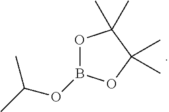

In some embodiments, M² is ⁺Li, ⁺ZnCl, ⁺MgCl, or ⁺CuLi.

Some embodiments include a method of chemical synthesis comprising:

reacting a compound of formula (IV):

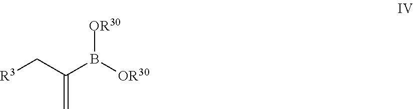

with a bifluoride to provide a compound of formula (V):

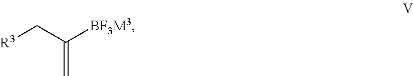

wherein

R³ is R^{30a}O—, R^{30a}S—, R^{30b}R^{30c}N—, or R^{30d};

R^{30a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30aa}, each optionally substituted with one or more R^{40a};

R^{30aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{40a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{40aa};

each R^{40aa} is separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{30b} and R^{30c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30bb}, each optionally substituted with one or more R^{40bc}, or R³⁰R^{30c}N— is a non-aromatic heterocycle optionally substituted with one or more R^{40bc} said non-aromatic heterocycle covalently bonded to the parent molecule through a —N— linkage, or R^{30b}R^{30c}N— is a C₁-C₂₀ alkylideneamino optionally substituted with one or more R^{40bc}, said C₁-C₂₀ alkylideneamino covalently bonded to the parent molecule through a —N— linkage, or R^{30b}R^{30c}N— is —N₃

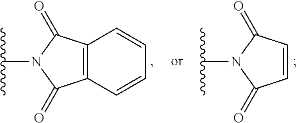

R^{30bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{40bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{30d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{40d};

each R^{40d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

M³ is ⁺Na, ⁺K, ⁺Li, ⁺MgX³, ⁺ZnX³, or ⁺CuLi; X³ is halo; and

each R³⁰ is separately C₁₋₂₀ alkyl or C₃₋₁₀ cycloalkyl, or —B(OR³⁰)₂ is

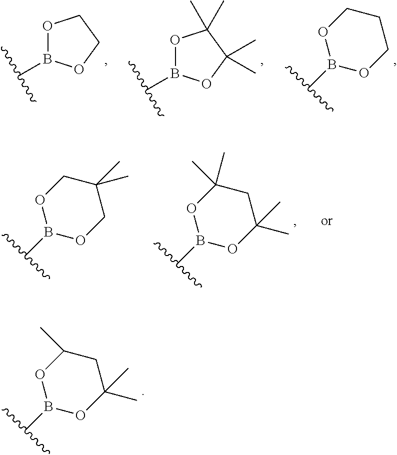

In some embodiments, the bifluoride can be K⁺HF₂⁻.

A compound having the formula (I):

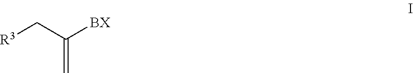

wherein:

R¹ is R^{1a}O—, R^{1a}S—, R^{1b}R^{1c}N—, or R^{1d};

R^{1a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};

R^{1aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{2a} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};

each R^{2aa} is separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc}, said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃,

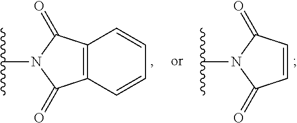

each R^{1bb} is separately hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{1d} is C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};

each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and BX is —BF₃M¹; and M¹ is a metal or metal salt.

In some embodiments, M¹ can be ⁺Na, ⁺K, ⁺Li, ⁺MgX¹, ⁺ZnX¹, or ⁺CuLi; and X¹ is halo. In some embodiments, M¹ can be ⁺K, ⁺Li, or ⁺MgX¹. In some embodiments, M¹ can be ⁺K (potassium cation). In some embodiments, R¹ can be R^{1a}O—, R^{1a}S—, or R^{1b}R^{1c}N—. In some embodiments, R¹ can be R^{1a}O— or R^{1a}S—. In some embodiments, R^{1a} can be C₁₋₆ alkyl, C₁₋₆ heteroalkyl, C₃₋₇ cycloalkyl, C₃₋₇ cycloalkenyl, C₂₋₆ alkenyl, C₂₋₆ alkynyl, aryl, heteroaryl, C₇₋₁₃ aralkyl, C₄₋₁₃ heteroaralkyl, or R^{1aa}, each optionally substituted with one or more R^{2a}; R^{1aa} can be acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, tert-butyldimethylsilyl, triethylsilyl, 2-trimethylsilylethyl, 2-(trimethylsilyl)ethoxymethyl, triisopropylsilyl, tert-butyl diphenylsilyl, or tert-butyldimethylsilyloxymethyl; each R^{2a} can be separately selected from the group consisting of C₁₋₆ alkyl, C₃₋₇ cycloalkyl, C₃₋₇ cycloalkenyl, C₂₋₆ alkenyl, C₂₋₆ alkynyl, aryl, heteroaryl, C₇₋₁₃ aralkyl, C₄₋₁₃ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, heterocycle, alkoxy, aryloxy, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2a}; each R^{2aa} can be separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, and p-methoxybenzyl. In some embodiments, R¹ can be R^{1b}R^{1c}N—. In some embodiments, R^{1b} and R^{1C} can each be independently C₁₋₆ alkyl, C₁₋₆ heteroalkyl, C₃₋₇ cycloalkyl, C₃₋₇ cycloalkenyl, C₂₋₆ alkenyl, C₂₋₆ alkynyl, aryl, heteroaryl, C₇₋₁₃ aralkyl, C₄₋₁₃ heteroaralkyl, or R^{1bb}, each optionally substituted with one or more R^{2bc}; each R^{1bb} can be separately acetyl, trifluoroacetyl, formyl, benzoyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl; each R^{2bc} can be separately selected from the group consisting of C₁₋₆ alkyl, aryl, heteroaryl, C₇₋₁₃ aralkyl, C₄₋₁₃ heteroaralkyl, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, heteroaryl, heterocycle, alkoxy, aryloxy, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino. In some embodiments, R^{1b}R^{1c}N— can be a non-aromatic heterocycle optionally substituted with one or more R^{2bc}, said non-aromatic heterocycle covalently bonded to the parent molecule through a —N— linkage; and each R^{2bc} can be separately selected from the group consisting of C₁₋₆ alkyl, arylalkylOC(═O)—, C₁₋₆ alkylOC(═O)—, cycloalkylC(═O)—, arylC(═O)—, oxo, and amino. In some embodiments, R^{1b}R^{1c}N— can be —N₃,

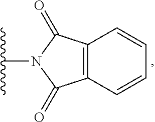

or

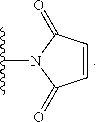

Some embodiments provide, a compound having the formula:

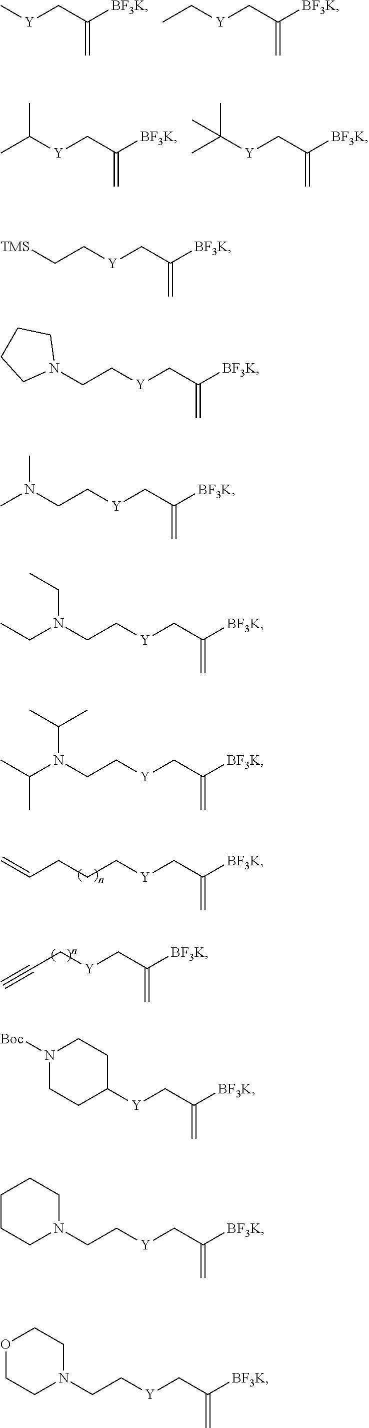

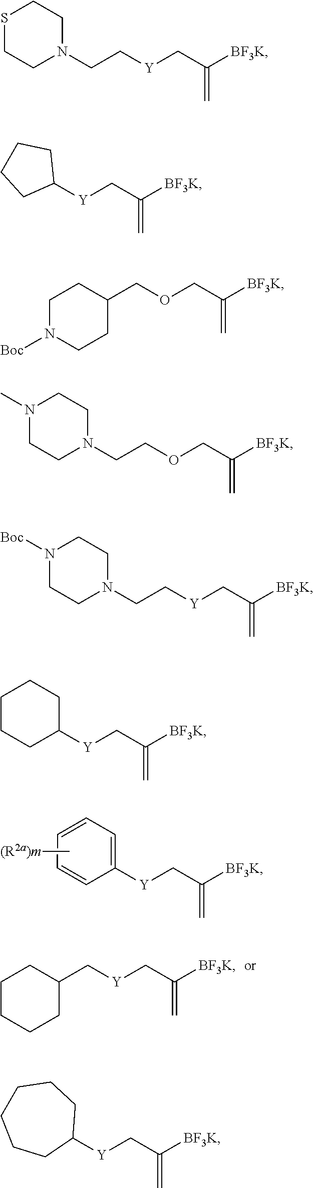

wherein Y is oxygen (O) or sulfur (S); m is an interger from 1-5; n is an interger from 1-10; and each R^{2a} is separately selected from the group consisting of C₁₋₆ alkyl, hydroxy, C₁₋₆ alkoxy, cyano, halo, isocyanato, thiocyanato, isothiocyanato, nitro, and amino.

Some embodiments provide, a compound having the formula:

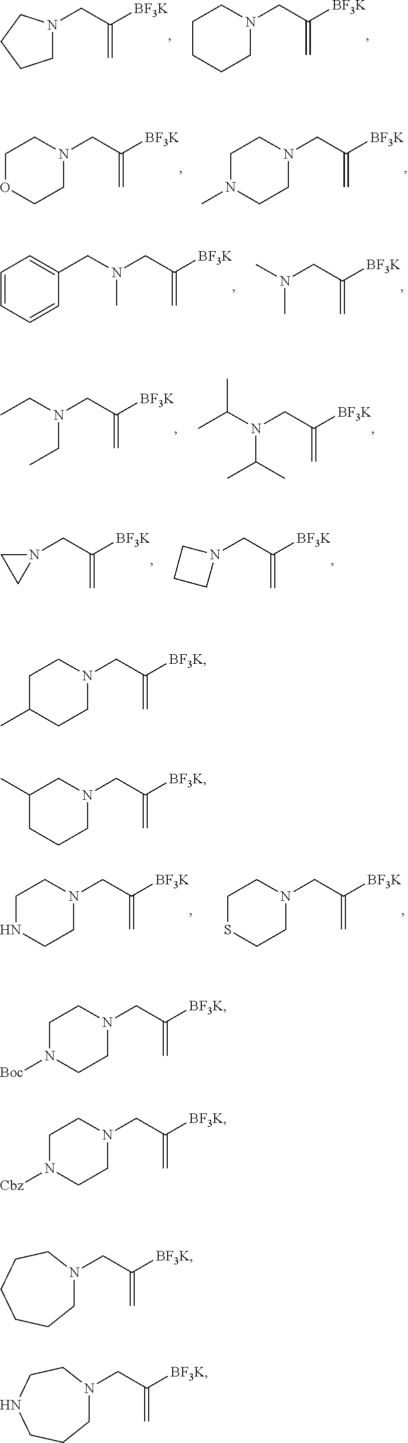

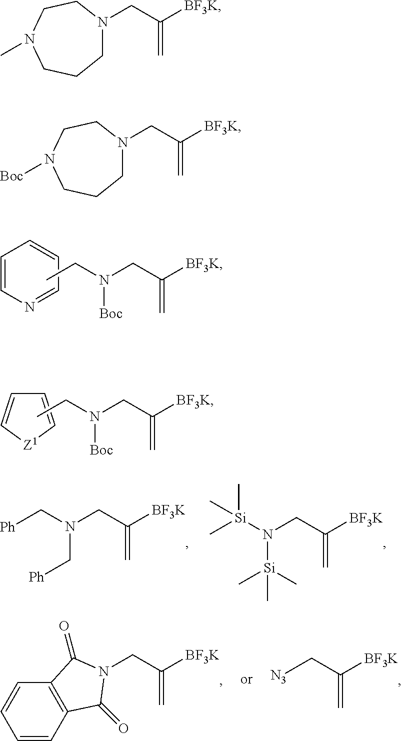

wherein Z¹ can be oxygen (O), sulfur (S), or NR²⁵; and R²⁵ can be hydrogen (H) or C₁₋₆ alkyl.

Some embodiments provide a compound having the formula (I):

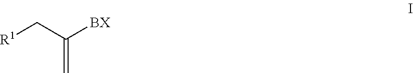

wherein:

R¹ is R^{1a}O—, R^{1a}S—, R^{1b}R^{1c}N—, or R^{1d};

R^{1a} is hydrogen (H), C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};

R^{1aa} is —N₃, acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{2a} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};

each R^{2aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc} said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃,

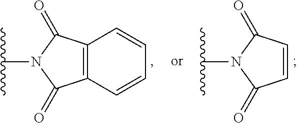

R^{1bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{1d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};

each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and BX is —B(OH)₂, —B(OC₁₋₆ alkyl)₃M¹, or B(OH)₃M¹; and M¹ is a metal or metal salt. In some embodiments, M¹ can be Na⁺, K⁺, Li⁺, ⁺MgX¹, ⁺ZnX¹, or ⁺CuLi; and; X¹ can be halo. In some embodiments, R¹ can be R^{1a}O—, R^{1a}S—, or R^{1b}R^{1c}N—.

Some embodiments provide a compound having the formula (I):

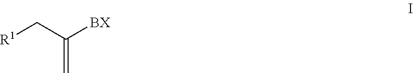

wherein:

R¹ is R^{1a}O—, R^{1a}S—, R^{1b}R^{1c}N—, or R^{1d};

R^{1a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};

R^{1aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;

each R^{2a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};

each R^{2aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;

R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc} said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃,

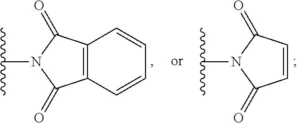

R^{1bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;

each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;

R^{1d} is C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};

each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃—O—(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and

BX is a boronic ester, with the proviso the compound having the formula (I) is not

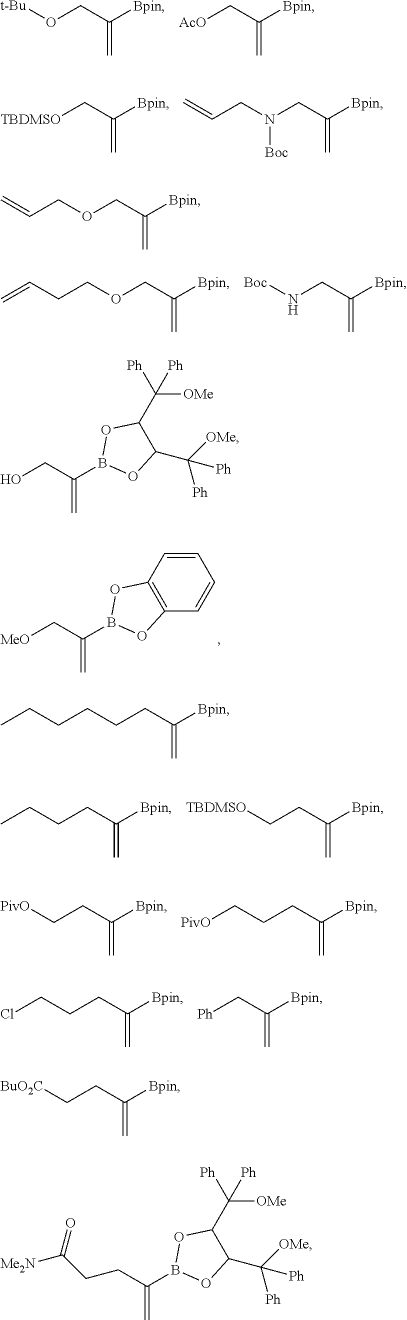

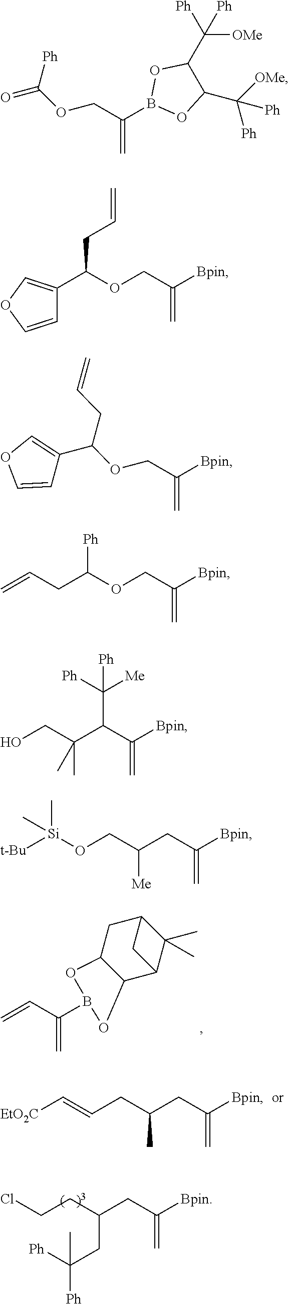

In some embodiments, BX is a boronic ester having the structure of:

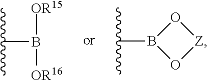

wherein:

R¹⁵ can be aryl, or C₁₋₆ alkyl, each optionally substituted with one or more R^{15a};

each R^{15a} can be separately halo, or C₁₋₆alkoxy optionally substituted with up to 9 halo;

R¹⁶ can be aryl, or C₁₋₆ alkyl, each optionally substituted with one or more R^{16a};

each R^{16a} can be separately halo, or C₁₋₆alkoxy optionally substituted with up to 9 halo;

Z can be —[C(R³)₂]ₜ—, each C(R³)₂ separately selected and optionally substituted with one or more halo;

t can be 1, 2, 3 or 4; and

each R³ can be separately H (hydrogen), C₁₋₆ alkyl or C₁₋₆alkoxy optionally substituted with up to 9 halo.

### BRIEF DESCRIPTION OF THE DRAWINGS

FIG. 1: Examples of Boronic acids and boronic acid derivatives

FIG. 2: Examples of allyl amine vinyl bromides as precursors of allyl amine vinyl boronic acids and boronic acid derivatives.

FIG. 3: Examples of allyl oxy vinyl bromides as precursors of allyl oxy vinyl boronic acids and boronic acid derivatives.

FIG. 4: Examples of allyl bromides as precursors of allyl vinyl boronic acids and boronic acid derivatives.

FIG. 5: Examples of allyl amine vinyl trifluoroboronates.

FIG. 6: Examples of allyl oxy vinyl trifluoroboronates.

FIG. 7: Examples of allyl vinyl trifluoroboronates.

FIG. 8: Synthesis of vinyl boronates.

FIG. 9: Synthesis of vinylpinacol boronates.

FIG. 10: Examples of allyl vinyl trifluoroboronates.

FIG. 11: Examples of allyl oxy vinyl trifluoroboronates

### DETAILED DESCRIPTION OF THE PREFERRED EMBODIMENTS

The term “aryl” as used herein refers to an aromatic ring or aromatic ring system such as phenyl, naphthyl, biphenyl, and the like. A phrase such as “C_{6 or 10} aryl” as used herein refers to the number of carbon atoms in the ring or ring system (i.e. 6 or 10), but does not characterize or limit any substituents of the aryl moiety.

The term “heteroaryl” as used herein refers to an aromatic ring or aromatic ring system having one or more oxygen atom, nitrogen atom, sulfur atom, or a combination thereof, which are part of the ring or ring system. Examples include thienyl, furyl, pyridinyl, quinolinyl, thiazolyl, benzooxazolyl, benzothiazolyl, benzoimidazolyl, benzothiazolyl, benzothienyl, benzofuryl, isoindolinyl, pyridinyl, imidazolyl, thiazolyl, oxazolyl, and the like. The term “fused bicyclic heteroaryl” as used herein refers to heteroaryl having a ring system of two rings, wherein two adjacent ring atoms are shared by both rings of the system. Examples include, but are not limited to, quinolinyl, benzooxazolyl, benzothiazolyl, benzoimidazolyl, benzothiazolyl, benzothienyl, benzofuryl, isoindolinyl, and the like

The term “heterocyclic” or “heterocyclyl” or “heterocycloalkyl” used herein refers to cyclic non-aromatic ring system moiety having at least one ring in which one or more ring atoms are not carbon, namely heteroatom. The heteroatoms are independently selected from oxygen, sulfur, and nitrogen. In fused ring systems, the one or more heteroatoms may be present in only one of the rings. Examples of heterocyclic groups include, but are not limited to, morpholinyl, tetrahydrofuranyl, dioxolanyl, pyrrolidinyl, pyranyl, piperidyl, piperazyl, and the like.

The term, “Het” used herein refers to an optionally substituted monocyclic, bicyclic, or tricyclic ring system comprising at least one heteroatom in the ring system backbone. The heteroatoms are independently selected from oxygen, sulfur, and nitrogen. The term, “Het” includes multiple fused ring systems. Moreover, the term “Het” includes fused ring systems that may have any degree of saturation provided that at least one ring in the ring system is not aromatic. The monocyclic, bicyclic, or tricyclic ring system may be substituted or unsubstituted, and can be attached to other groups via any available valence, preferably any available carbon or nitrogen. Preferred monocyclic ring systems are of 4, 5, 6, 7, or 8 members. Six membered monocyclic rings contain from up to three heteroatoms wherein each heteroatom is individually selected from oxygen, sulfur, and nitrogen, and wherein when the ring is five membered, preferably it has one or two heteroatoms wherein each heteroatom is individually selected from oxygen, sulfur, and nitrogen. Preferred bicyclic cyclic ring systems are of 8 to 12 members and include spirocycles. The term “Het” encompasses Heteroaryl fused to a non-aromatic ring system.

The term “alkyl” refers to a branched or unbranched fully saturated acyclic aliphatic hydrocarbon group. An alkyl may be branched or straight chain. Alkyls may be substituted or unsubstituted. Alkyls include, but are not limited to, methyl, ethyl, propyl, isopropyl, butyl, isobutyl, tertiary butyl, pentyl, hexyl, and the like, each of which may be optionally substituted.

In certain embodiments, an alkyl comprises 1 to 20 carbon atoms (whenever it appears herein, a numerical range such as “1 to 20” refers to each integer in the given range; e.g., “1 to 20 carbon atoms” means that an alkyl group may comprise only 1 carbon atom, 2 carbon atoms, 3 carbon atoms, etc., up to and including 20 carbon atoms, although the term “alkyl” also includes instances where no numerical range of carbon atoms is designated). An alkyl may be designated as “C₁₋₆ alkyl” or similar designations. By way of example only, “C₁₋₄ alkyl” indicates an alkyl having one, two, three, or four carbon atoms, e.g., the alkyl is selected from methyl, ethyl, propyl, iso-propyl, butyl, iso-butyl, sec-butyl, and tert-butyl.

An “aralkyl,” or “arylalkyl,” is an aryl group connected, as a substituent, via an alkyl group. The alkyl and aryl group of an aralkyl may be substituted or unsubstituted. Examples include but are not limited to benzyl, substituted benzyl, 2-phenylethyl, 3-phenylpropyl, and naphtylalkyl.

A “heteroaralkyl,” or “heteroarylalkyl,” is a heteroaryl group connected, as a substituent, via an alkyl group. The alkyl and heteroaryl group of heteroaralkyl may be substituted or unsubstituted. Examples include but are not limited to 2-thienylmethyl, 3-thienylmethyl, furylmethyl, thienylethyl, pyrrolylalkyl, pyridylalkyl, isoxazollylalkyl, and imidazolylalkyl, and their substituted as well as benzo-fused analogs.

The term “alkenyl” used herein refers to a monovalent straight or branched chain aliphatic hydrocarbon moiety of from two to twenty carbon atoms containing at least one carbon-carbon double bond including, but not limited to, 1-propenyl, 2-propenyl, 2-methyl-1-propenyl, 1-butenyl, 2-butenyl, and the like. In certain embodiments, an alkenyl comprises 2 to 20 carbon atoms (whenever it appears herein, a numerical range such as “2 to 20” refers to each integer in the given range; e.g., “2 to 20 carbon atoms” means that an alkenyl group may comprise only 2 carbon atoms, 3 carbon atoms, etc., up to and including 20 carbon atoms, although the term “alkenyl” also includes instances where no numerical range of carbon atoms is designated). An alkenyl may be designated as “C₂₋₆ alkenyl” or similar designations. By way of example only, “C₂₋₄ alkenyl” indicates an alkenyl having two, three, or four carbon atoms, e.g., the alkenyl is selected from ethenyl, propenyl, and butenyl.

The term “alkynyl” used herein refers to a monovalent straight or branched chain aliphatic hydrocarbon moiety of from two to twenty carbon atoms containing at least one carbon-carbon triple bond including, but not limited to, 1-propynyl, 1-butynyl, 2-butynyl, and the like. In certain embodiments, an alkynyl comprises 2 to 20 carbon atoms (whenever it appears herein, a numerical range such as “2 to 20” refers to each integer in the given range; e.g., “2 to 20 carbon atoms” means that an alkynyl group may comprise only 2 carbon atoms, 3 carbon atoms, etc., up to and including 20 carbon atoms, although the term “alkynyl” also includes instances where no numerical range of carbon atoms is designated). An alkynyl may be designated as “C₂-C₆ alkynyl” or similar designations. By way of example only, “C₂-C₄ alkynyl” indicates an alkenyl having two, three, or four carbon atoms, e.g., the alkenyl is selected from ethynyl, propynyl, and butynyl.

The term “cycloalkyl” used herein refers to saturated aliphatic ring system moiety having three to twenty carbon atoms. A cycloalkyl refers to monocyclic and polycyclic saturated aliphatic ring system including, but not limited to, cyclopropyl, cyclopentyl, cyclohexyl, cycloheptyl, bicyclo[4.4.0]decanyl, bicyclo[2.2.1]heptanyl, adamantyl, norbornyl, and the like. In certain embodiments, a cycloalkyl comprises 3 to 20 carbon atoms (whenever it appears herein, a numerical range such as “3 to 20” refers to each integer in the given range; e.g., “3 to 20 carbon atoms” means that a cycloalkyl group may comprise only 3 carbon atoms, etc., up to and including 20 carbon atoms, although the term “cycloalkyl” also includes instances where no numerical range of carbon atoms is designated). A cycloalkyl may be designated as “C₃-C₇ cycloalkyl” or similar designations. By way of example only, “C₃-C₆ cycloalkyl” indicates an alkenyl having two, three, four, five or six carbon atoms, e.g., the cycloalkyl is selected from cyclopropyl, cyclobutyl, cyclopentyl, and cyclohexyl.

The term “cycloalkenyl” used herein refers to aliphatic ring system moiety having three to twenty carbon atoms having at least one carbon-carbon double bond in the ring. A cycloalkenyl refers to monocyclic and polycyclic unsaturated aliphatic ring system including, but are not limited to, cyclopropenyl, cyclopentenyl, cyclohexenyl, cycloheptenyl, bicyclo[3.1.0]hexyl, norbornylenyl, 1,1′-bicyclopentenyl, and the like. In certain embodiments, a cycloalkenyl comprises 3 to 20 carbon atoms (whenever it appears herein, a numerical range such as “3 to 20” refers to each integer in the given range; e.g., “3 to 20 carbon atoms” means that a cycloalkenyl group may comprise only 3 carbon atoms, etc., up to and including 20 carbon atoms, although the term “cycloalkenyl” also includes instances where no numerical range of carbon atoms is designated). A cycloalkenyl may be designated as “C₃-C₇ cycloalkenyl” or similar designations. By way of example only, “C₃-C₆ cycloalkenyl” indicates an alkenyl having two, three, four, five or six carbon atoms, e.g., the cycloalkyl is selected from cyclopropenyl, cyclobutenyl, cyclopentenyl, and cyclohexenyl.

The term “alkoxy” used herein refers to straight or branched chain alkyl moiety covalently bonded to the parent molecule through an —O— linkage. Examples of alkoxy groups include, but are not limited to, methoxy, ethoxy, propoxy, isopropoxy, butoxy, n-butoxy, sec-butoxy, t-butoxy and the like. An alkoxy may be designated as “C₁-C₆ alkoxy” or similar designations. By way of example only, “C₁-C₄ alkoxy” indicates an alkyl having one, two, three, or four carbon atoms, e.g., the alkoxy is selected from methoxy, ethoxy, propoxy, iso-propoxy, butoxy, iso-butoxy, sec-butoxy, and tert-butoxy.

As used herein, “alkylthio” refers to the formula —SR, covalently bonded to the parent molecule through a —S— linkage. Examples of alkylthio groups include, but are not limited to, methylmercapto, ethylmercapto, n-propylmercapto, 1-methylethylmercapto (isopropylmercapto), n-butylmercapto, iso-butylmercapto, sec-butylmercapto, tert-butylmercapto, and the like. An alkylthio may be substituted or unsubstituted.

The term “heteroalkyl” refers to a group comprising an alkyl and one or more heteroatoms. Examples of heteroalkyls include, but are not limited to, CH₃NHCH₂—, CH₃NHCH₂CH₂—, CH₃CH₂NHCH₂CH₂—, CH₃CH₂NHCH₂CH₂CH₂—, CH₃NHCH₂CH₂—, CH₃OCH₂—, CH₃OCH₂CH₂—, CH₃CH₂OCH₂CH₂—, CH₃CH₂OCH₂CH₂CH₂—, CH₃OCH₂CH₂—, CH₃SCH₂—, CH₃SCH₂CH₂—, CH₃CH₂SCH₂CH₂—, CH₃CH₂SCH₂CH₂CH₂—, CH₃SCH₂CH₂—, and the like.

As used herein, “aryloxy” refers to RO—, covalently bonded to the parent molecule through an —O— linkage, where R includes, but is not limited to, phenyl. Aryloxyl may be substituted or unsubstituted.

As used herein, “arylthio” refers to RS—, covalently bonded to the parent molecule through an —S— linkage, where R includes, but is not limited to, phenyl. Arylthio may be substituted or unsubstituted.

As used herein, “halo” or “halogen” refers to F (fluoro), Cl (chloro), Br (bromo) or I (iodo). In some embodiments, the “halo” may be ⁻F (fluoride), ⁻Cl (chloride), ⁻Br (bromide), or ⁻I (iodide) as the anion component of a salt.

As used herein, “haloalkyl” refers to an alkyl group-, covalently bonded to the parent molecule through a —C— linkage, in which one or more of the hydrogen atoms are replaced by halogen. Such groups include, but are not limited to, chloromethyl, fluoromethyl, difluoromethyl, trifluoromethyl and 1-chloro-2-fluoromethyl, 2-fluoroisobutyl. A haloalkyl may be substituted or unsubstituted.

As used herein, “haloalkoxy” refers to an “RO—” group-, covalently bonded to the parent molecule through an —O— linkage, in which R is a haloalkyl group. Such groups include, but are not limited to, chloromethoxy, fluoromethoxy, difluoromethoxy, trifluoromethoxy and 1-chloro-2-fluoromethoxy, 2-fluoroisobutyloxy. A haloalkoxy may be substituted or unsubstituted.

As used herein, “alkylideneamino” refers to a moiety of from one to twenty carbon atoms containing at least one carbon-nitrogen double bond where the moiety is connected to the parent molecule through an —N— linkage. Such groups include, but are not limited to, methylideneamino, ethylideneamino, methylethylideneamino, propylideneamino, 1-methylpropylideneaminyl, 2-methylpropylideneamino, butylideneamino, 1-methylbutylideneamino, 2-methylbutylideneamino, cyclopropylideneamino, cyclobutylideneamino, cyclopentylideneamino, cyclohexylideneamino and the like.

As used herein, “boronic ester,” “boronate ester,” or “boronic acid ester” refers to a boronic acid where a hydrogen of a hydroxyl group is replaced by an alkyl or aryl group. In some embodiments, the hydrogen of both hydroxyl groups is replaced by an alkyl or aryl group. When the hydrogen of both hydroxyl groups is replaced the boronic ester can include a cyclic moiety selected from the group consisting of

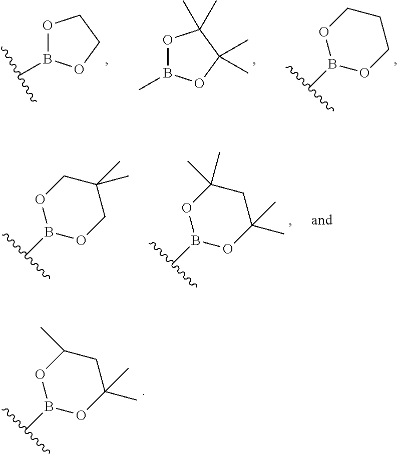

A boronic ester may be substituted or unsubstituted.

The term “O-carboxy” refers to the group consisting of formula RC(═O)O—, covalently bonded to the parent molecule through an —O— linkage.

The term “C-carboxy” refers to the group consisting of formula —C(═O)OR, covalently bonded to the parent molecule through a —C— linkage.

The term “acetyl” refers to the group consisting of formula —C(═O)CH₃, covalently bonded to the parent molecule through a —C— linkage.

The substituent “R” appearing by itself and without a number designation refers to a substituent selected from alkyl, cycloalkyl, aryl, heteroaryl (bonded through a ring carbon) and non-aromatic heterocycle (bonded through a ring carbon).

The term “cyano” refers to the group consisting of formula —CN, covalently bonded to the parent molecule through a —C— linkage.

The term “isocyanato” refers to the group consisting of formula —NCO, covalently bonded to the parent molecule through a —N— linkage.

The term “thiocyanato” refers to the group consisting of formula —CNS, covalently bonded to the parent molecule through a —C— linkage.

The term “isothiocyanato” refers to the group consisting of formula —NCS, covalently bonded to the parent molecule through a —N— linkage.

The term “sulfonyl” refers to the group consisting of formula —S(═O)—R, covalently bonded to the parent molecule through a —S— linkage.

The term “S-sulfonamido” refers to the group consisting of formula —S(═O)₂NR, covalently bonded to the parent molecule through a —S— linkage.

The term “N-sulfonamido” refers to the group consisting of formula RS(═O)₂NH—, covalently bonded to the parent molecule through a —N— linkage.

The term “O-carbamyl” refers to the group consisting of formula —OC(═O)—NR, covalently bonded to the parent molecule through a —O— linkage.

The term “N-carbamyl” refers to the group consisting of formula ROC(═O)NH—, covalently bonded to the parent molecule through a —N— linkage.

The term “O-thiocarbamyl” refers to the group consisting of formula —OC(═S)—NR, covalently bonded to the parent molecule through a —O— linkage.

The term “N-thiocarbamyl” refers to the group consisting of formula ROC(═S)NH—, covalently bonded to the parent molecule through a —N— linkage.

The term “C-amido” refers to the group consisting of formula —C(═O)—NR₂, covalently bonded to the parent molecule through a —C— linkage.

The term “N-amido” refers to the group consisting of formula RC(═O)NH—, covalently bonded to the parent molecule through a —N— linkage.

The term “oxo” refers to the group consisting of formula ═O.

The term “keto” and “carbonyl” used herein refers to C═O.

The term “thiocarbonyl” used herein refers to C═S.

The term “ester” refers to a chemical moiety with formula —(R)ₙ—C(═O)OR′, where R and R′ are independently selected from alkyl, cycloalkyl, aryl, heteroaryl (bonded through a ring carbon) and non-aromatic heterocycle (bonded through a ring carbon), where n is 0 or 1, covalently bonded to the parent molecule through a —C— linkage.

The term “amide” refers to a chemical moiety with formula —(R)ₙ—C(═O)NHR′ or —(R)ₙ—NHC(═O)R′, covalently bonded to the parent molecule through a —C— or —N— linkage, where R is selected from alkyl, cycloalkyl, aryl, heteroaryl (bonded through a ring carbon) and heteroalicyclic (bonded through a ring carbon), where n is 0 or 1 and R′ is selected from hydrogen, alkyl, cycloalkyl, aryl, heteroaryl (bonded through a ring carbon) and heteroalicyclic (bonded through a ring carbon), where n is 0 or 1. In certain embodiments, an amide may be an amino acid or a peptide.

The term “amino” refers to a chemical moiety with formula —NHR′R″, covalently bonded to the parent molecule through a —N— linkage, where R′ and R″ are each independently selected from hydrogen, alkyl, cycloalkyl, aryl, heteroaryl (bonded through a ring carbon) and heteroalicyclic (bonded through a ring carbon).

The terms “amine,” “hydroxy,” and “carboxyl” include such groups that have been esterified or amidated. Procedures and specific groups used to achieve esterification and amidation are known to those of skill in the art and can readily be found in reference sources such as Greene and Wuts, Protective Groups in Organic Synthesis, 3^{rd} Ed., John Wiley & Sons, New York, N.Y., 1999, which is incorporated herein in its entirety.

The terms “bifluoride,” “hydrogendifluoride,” and “hydrogenfluoride” refers to the group consisting of formula M⁺HF2⁻ or NH₄⁺HF2⁻. Examples of formula M⁺HF₂⁻ include, but are not limited to, K⁺HF₂⁻, and Na⁺HF₂⁻.

As used herein the term “metal” refers to an element from group Ia, IIa, Ib, or IIb, from the periodic table or mixtures thereof.

Unless otherwise indicated, the term “optionally substituted,” refers to a group in which none, one, or more than one of the hydrogen atoms has been replaced with one or more group(s) individually and independently selected from: alkyl, alkenyl, cycloalkenyl, alkynyl, heteroalkyl, haloalkyl, cycloalkyl, aryl, arylalkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, —C(═O)NHNH₂, heteroaryl, heterocycle, hydroxy, alkoxy, aryloxy, mercapto, alkylthio, arylthio, cyano, halo, carbonyl, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, silyl, trihalomethanesulfonyl, and amino, including mono- and di-substituted amino groups, and the protected derivatives of amino groups. The protecting groups that can form the protective derivatives of the above substituents are known to those of skill in the art and can be found in references such as Greene and Wuts Protective Groups in Organic Synthesis; John Wiley and Sons: New York, 1999.

The term “stereoisomers” as used herein means isomers that possess identical constitution, but which differ in the arrangement of their atoms in space. Including, for example, all enantiomers, diastereomers, geometric isomers, and atropisomers.

Asymmetric carbon atoms may be present in the compounds described. All such stereoisomers, both in a pure form or as a mixture of isomers, are intended to be included in the scope of a recited compound. In certain cases, compounds can exist in tautomeric forms. All tautomeric forms are intended to be included in the scope. Likewise, when compounds contain a double bond, there exists the possibility of cis- and trans-type isomeric forms of the compounds. Both cis- and trans-isomers, both in pure form as well as mixtures of cis- and trans-isomers, are contemplated. Thus, reference herein to a compound includes all of the aforementioned isomeric forms unless the context clearly dictates otherwise.

Isotopes may be present in the compounds described. Each chemical element as represented in a compound structure may include any isotope of said element. For example, in a compound structure a hydrogen atom may be explicitely disclosed or understood to be present in the compound. At any position of the compound that a hydrogen atom may be present, the hydrogen atom can be any isotope of hydrogen, including but not limited to hydrogen-1 (protium) and hydrogen-2 (deuterium). Thus, reference herein to a compound encompasses all potential isotopic forms unless the context clearly dictates otherwise.

Wherever a substituent as depicted as a di-radical (i.e., has two points of attachment to the rest of the molecule), it is to be understood that the substituent can be attached in any directional configuration unless otherwise indicated. Thus, for example, a substituent depicted as —OCH₂— or

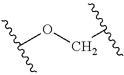

includes the substituent being oriented such that the oxygen is attached at the leftmost attachment point of the parent molecule as well as attached at the rightmost attachment point of the parent molecule. Thus, —OCH₂— and

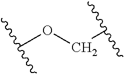

are equivalent to —CH₂O— and

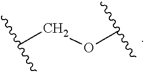

It is to be understood that certain moiety naming conventions can include either a mono-radical or a di-radical, depending on the context. For example, where a substituent requires two points of attachment to the rest of the molecule, it is understood that the substituent is a di-radical. A substituent identified as alkyl, that requires two points of attachment, includes di-radicals such as —CH₂—, —CH₂CH₂—, —CH₂CH(CH₃)CH₂—, and the like; a substituent depicted as alkoxy that requires two points of attachment, includes di-radicals such as —OCH₂—, —OCH₂CH₂—, —OCH₂CH(CH₃)CH₂—, and the like: and a substituent depicted as arylC(═O)— that requires two points of attachment, includes di-radicals radicals such as

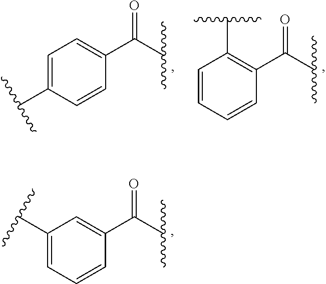

and the like.

Where a range of values is provided, it is understood that each intervening value, to the tenth of the unit of the lower limit unless the context clearly dictates otherwise, between the upper and lower limit of that range and any other stated or intervening value in that stated range is encompassed within the embodiments. The upper and lower limits of these smaller ranges may independently be included in the smaller ranges is also encompassed within the embodiments, subject to any specifically excluded limit in the stated range. Where the stated range includes one or both of the limits, ranges excluding either both of those included limits are also included in the embodiments.

Unless defined otherwise, all technical and scientific terms used herein have the same meaning as commonly understood by one of ordinary skill in the art to which the embodiments belong. Although any methods and materials similar or equivalent to those described herein can also be used in the practice or testing of the embodiments, the preferred methods and materials are now described. All publications mentioned herein are incorporated herein by reference to disclose and describe the methods and/or materials in connection with which the publications are cited.

It must be noted that as used herein and in the appended claims, the singular forms “a,” “and,” and “the” include plural referents unless the context clearly dictates otherwise. Thus, for example, reference to “a method” includes a plurality of such methods.

As employed herein, the following terms have their accepted meaning in the chemical literature.

Ac Acetyl

AcOH Acetic acid

anhyd. anhydrous

aq. aqueous

Bn benzyl

Boc tert-Butoxycarbonyl

Bu n-Butyl

Cat. Catalytic

Cbz Benzyloxycarbonyl

° C. Temperature in degrees Centigrade

de diasteriomeric excess

DIBAL Diisobutylaluminum hydride

DMAP 4-Dimethylaminopyridine

DMA Dimethylacetamide

DME Dimethoxyethane

DMF N,N′-Dimethylformamide

DMSO Dimethyl sulfoxide

Ee enantiomeric excess

Et₂O Diethyl ether

EtOAc Ethyl acetate

EtOH Ethanol

M Metal

MeOH Methanol

MeCN Acetonitrile

NH₄OAc Ammonium acetate

NMM N-Methylmorpholine

NMP N-Methyl-2-pyrrolidinone

NMPU 1,3-Dimethyl-3,4,5,6-tetrahydro-2(1H)-pyrimidinone

PG Protecting group

Pd/C Palladium on activated carbon

pin pinacol or pinocolate

RCM Ring closing metathesis

sBuLi sec-Butylithium

t Tert

t-Bu tert-butyl

t-BuLi tert-Butyllithium

Tert tertiary

THF Tetrahydrofuran

TMEDA Tetramethylethylenediamine

TMS Trimethylsilyl

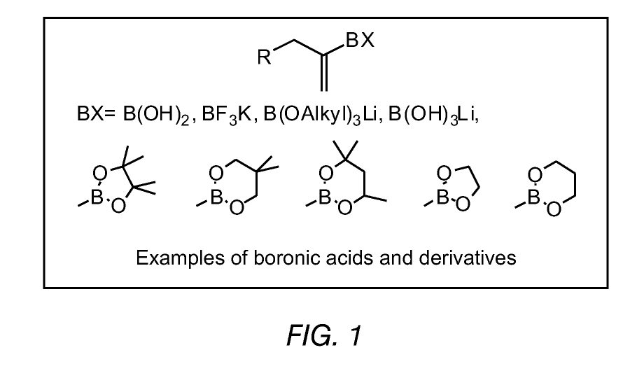

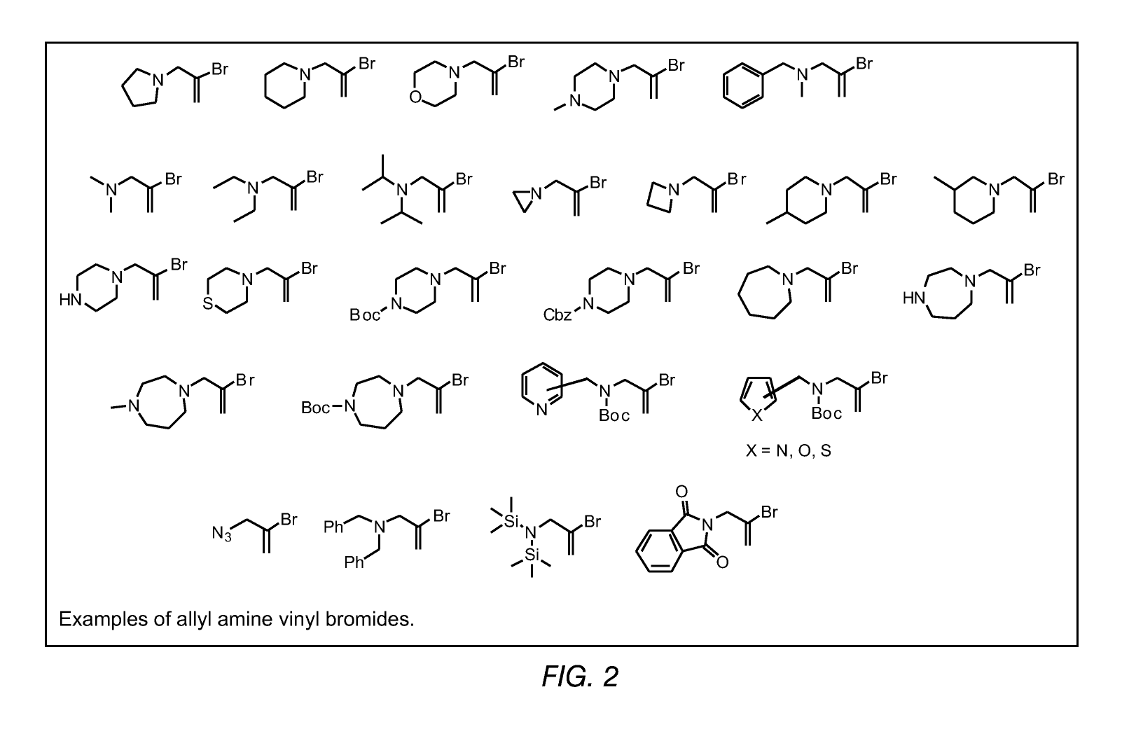

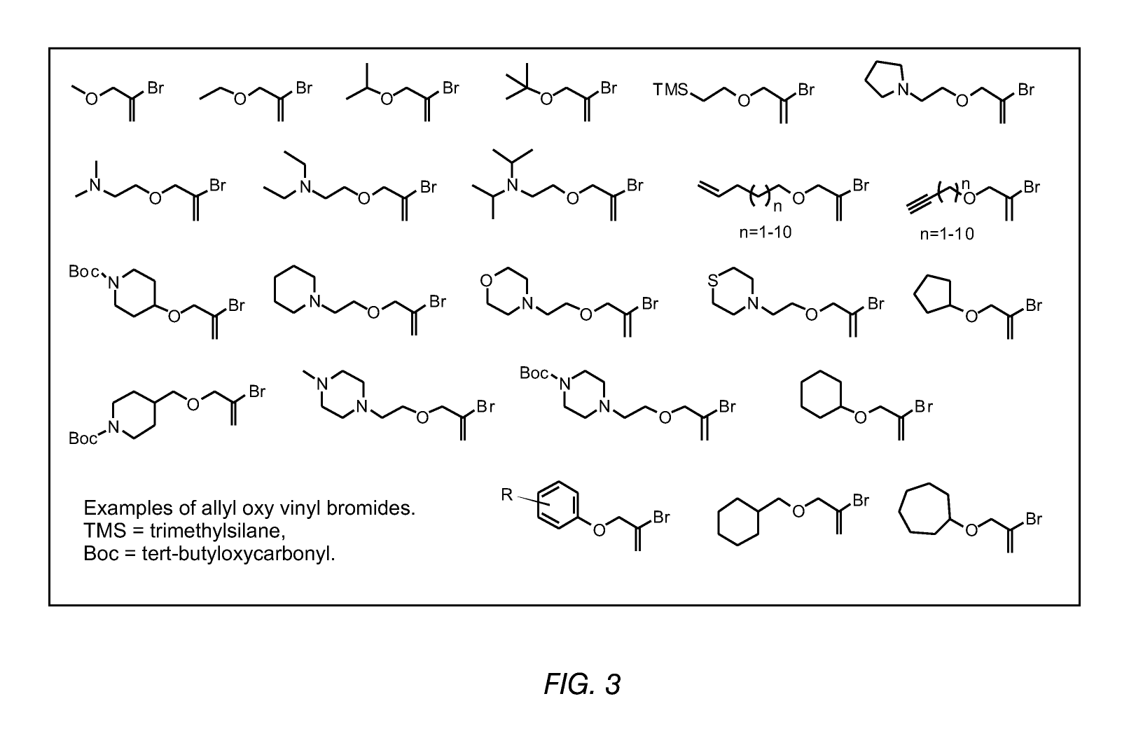

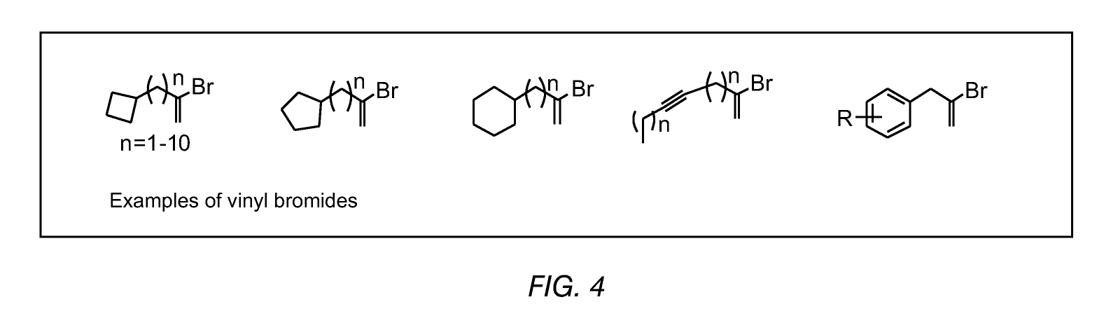

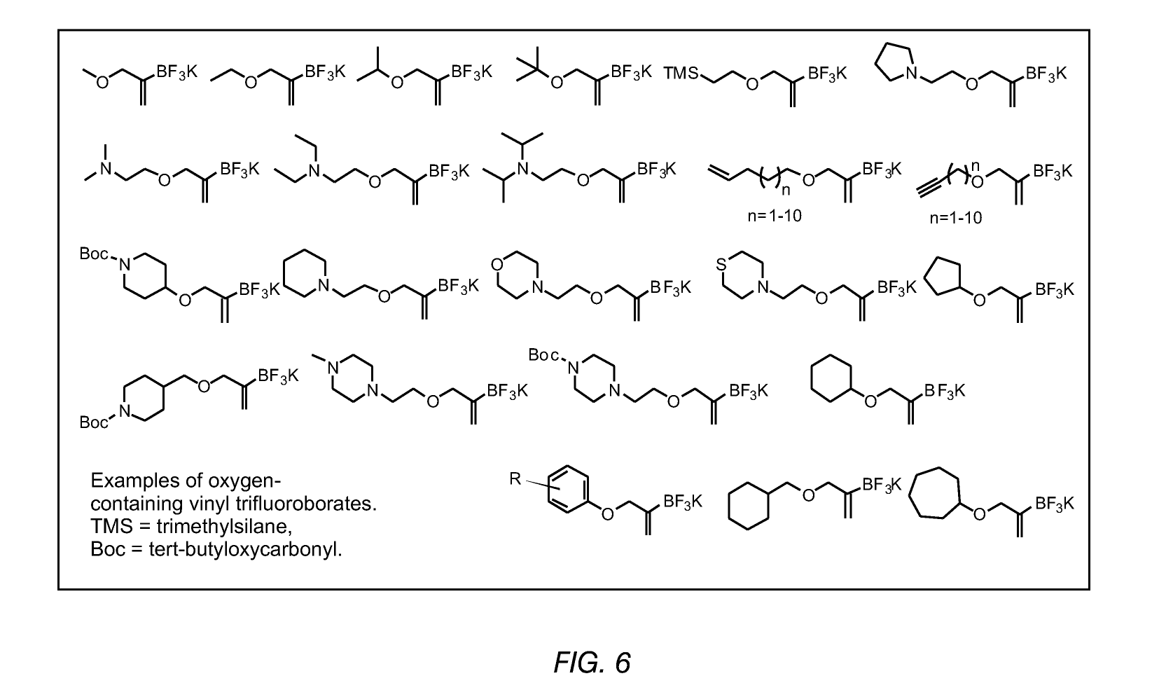

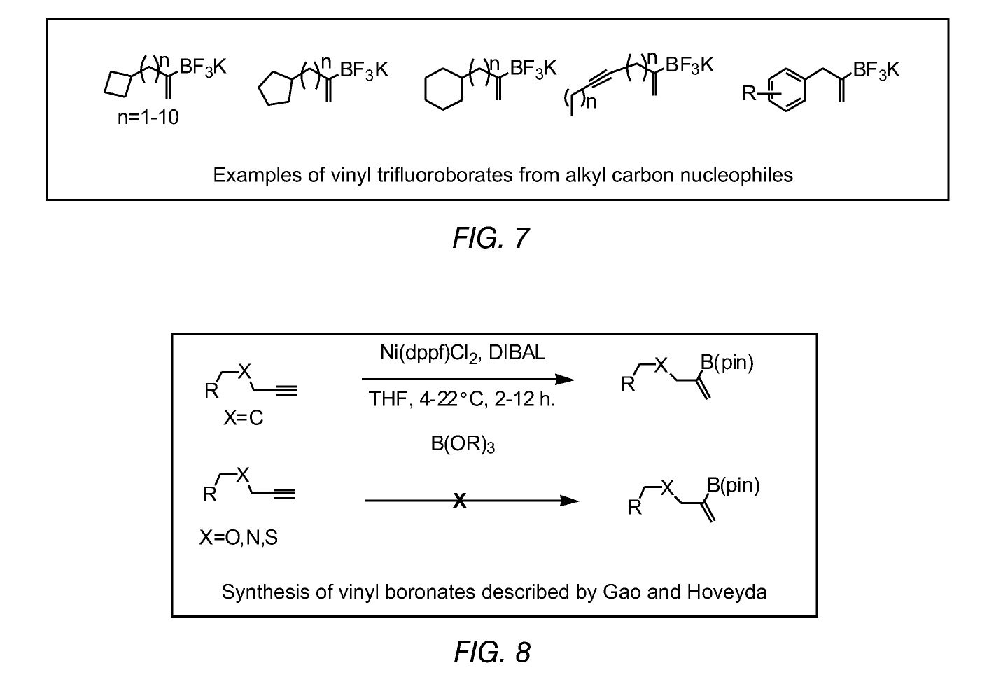

As depicted in FIG. 1, R represents a substituent group at the allylic center including but are not limited to groups mentioned in FIG. 2-7. This R substituent group can be systematically varied to generate a substituted internal vinyl-boronic acid and substituted internal vinyl-boronic acid derivative.

As depicted in Scheme 1, the bromide at the allylic position of (1) can be substituted with a wide variety of nucleophiles. The most common ones being: N-based nucleophiles from amines, O-based nucleophiles from alcohols, S-based nucleophiles from thiols, C-based nucleophiles from organometallic carbanions, such as in Grignard reagents, lithiates, cuprates etc.

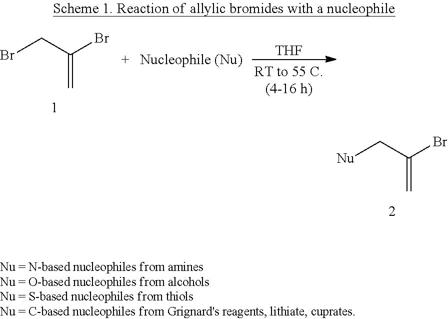

FIGS. 2-4 provide examples of vinyl-bromides derived from common nucleophiles. These vinyl bromides by themselves can be valuable building blocks owing to the fact that they possess functional groups that can be further modified in synthesis of more complex molecules. In some embodiments, the nucleophile in Scheme 1 can be replaced with a compound containing a nucleofuge, where 2-bromoallyl alcohol replaces 2-bromoallyl bromide (1). The nucleophile from 2-bromoallyl alcohol can react with a wide variety of nucleofuge containing compounds to provide compound 2.

The method depicted in Scheme 1 can readily provide allyl vinyl bromides. However, methods for generating vinyl bromides, such as starting with substituted alkynes (Moran W. J. et al. Org. Lett. (2006), 8(11), 2413-15) are not useful to generate internal vinyl bromides with a heteroatom in the allylic position due to Lewis acid, for example boron tribromide (BBr₃), cleavage of the molecule. This limits the types of methods for generating the internal vinyl-bromides to afford the desired internal vinyl-boronate.

The bromine atom in the substituted internal vinyl-bromides can be replaced to afford the corresponding boronic acids and boronic acid derivatives as shown in Scheme 2.

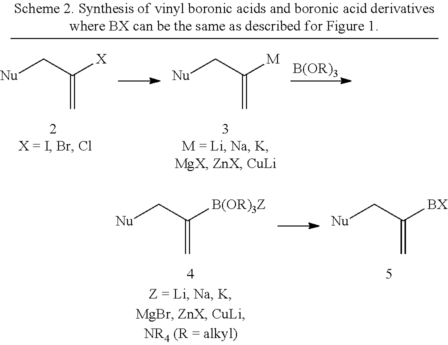

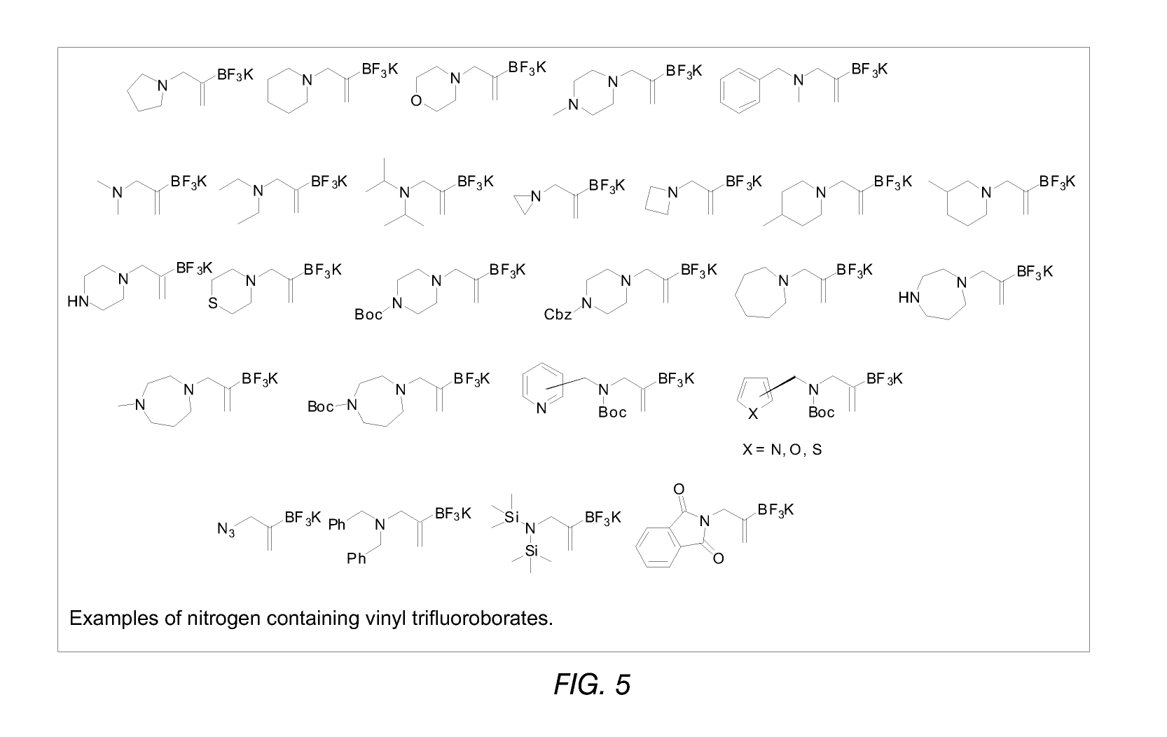

FIGS. 5-7 disclose examples of substituted internal vinyl-trifluoroborates obtained from the corresponding bromides in FIGS. 2-4.

The substituted internal vinyl-boronic acid and its derivatives can be synthesized by lithiating the vinyl-bromides, for example by using tert-butyllithium, to afford vinyl lithium (3) (Scheme 2) which can be then quenched with electrophiles (Scheme-2, Step-2), such as alkylborate (i.e. B(OR)₃) containing 1-12 carbons, to afford the corresponding borate salt (4). The alkylborates include, but are not limited to, triisopropylborate, trimethylborate, isopropyl-pinacol-borate and the like Under appropriate work-up conditions, the corresponding boronic acid or its derivative (5) can be obtained with all three-steps performed in one pot. Alternatively, borate salts (4) can also be isolated and used for subsequent syntheses. The borate salt (4) can be hydrolyzed to obtain free boronic acid by treating with dilute acids or can be converted into appropriate boronate esters shown in FIG. 1 by treating the borate salt (4) or the boronic acids with the appropriate diols. Alternatively, borate salt (4) can be treated with bifluoride to afford vinyl-trifluoroborates.

Lithiated substituted internal vinyl-bromides (3 in Scheme 2) can also be potentially quenched with many other electrophiles to generate different class of building blocks, such as, vinyl-carboxaldehyde, vinyl-carboxylic acids, tin-compounds, silyloxy compounds etc as shown in Scheme 4. The methodology developed herein has potential to generate a large variety of building blocks.

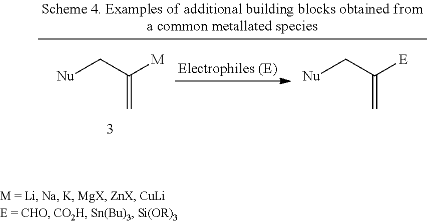

Methods mentioned in the literature to generate boronic aid derivatives, for example by diboron (e.g. bis(pinacolato)diboron) coupling reactions of the vinyl halides and the triflates, may suffer from significant limitations.

Gao and Hoveyda (J. Am. Chem. Soc. 2010, 132: 10961-10963) have shown that alkyl or select aryl terminal alkynes, in the presence of nickel catalyst and DIBAL, hydroaluminates, when quenched with borate, generates internal vinyl-boronate (FIG. 8). However, this approach cannot be used to generate internal vinyl-boronates with a heteroatom in the allylic position, as the molecule falls apart by β-elimination. This limits the approach to generate the desired internal vinyl-boronate.

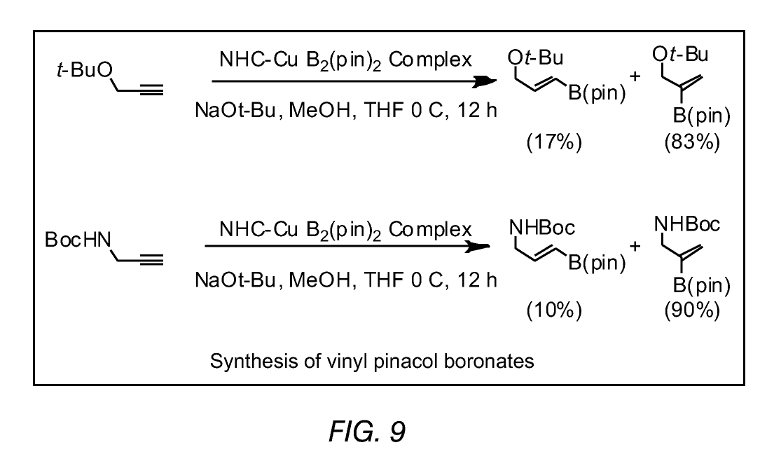

Lee et al. (J. Am. Chem. Soc. 2009, 131: 18234-18235) report a Cu-catalyzed protocol for conversion of terminal alkynes to enantiomerically enriched diboronates. The approach is directed to generating a terminal vinyl boronate followed by conversion of the terminal vinyl boronate to afford enantiomerically enriched diboronates. In the discussion of regioselectivity in producing terminal vinyl boronates they disclose formation of substituted internal vinyl-pinacol-boronates from terminal alkynes. They report using a propargyl ether and N-Boc-propargyl amine affords a mixture of regioisomers (FIG. 9). In contrast, the approach disclosed in Scheme 1 allows generation of a large number of regiospecific allyl vinyl boronates.

The present disclosure will be best understood by referring to the example that follows. These examples are not intended to limit the scope of the embodiments or the manner by which they can be practiced. In any case, the following examples are merely for the purpose of illustration and are not to be regarded as limiting scope of the embodiments or the manner in which they can be practiced. Unless specifically indicated otherwise, parts and percentages are given by weight.

### Example 1

### 2-Bromo-3-(N-benzylmethylamino)prop-1-ene

To a stirring solution of N-benzylmethylamine (121.2 g, 1.0 mmol) and triethylamine (126.6 g, 1.25 mmol) in THF (1500 mL) at room temperature was added 2,3-dibromopropene (200 g, 1.0 mmol) dropwise. The resulting reaction mixture was heated to 35° C. After 16 h, the reaction was diluted with ethyl ether (1000 mL) and water (500 mL). The organic layer was collected and carefully treated with 2N HCl (1000 mL) and mixed well. The aqueous layer was collected, cooled in ice-water bath to 5-10° C. and then neutralized with solid NaOH keeping the temperature below 15° C. The solution was checked to be ˜pH 12. The aqueous layer was extracted two times with ethyl ether (1000 mL). The combined ether layers was washed with brine (300 mL), dried over magnesium sulfate, filtered, the filtrate was concentrated on a rotary evaporator to obtain the crude product as a reddish-yellow liquid. The crude product was distilled under vacuum to collect the product at 87-89° C. (0.5 mmHg) as a clear liquid. Yield: 238 g, 83%.

### Example 2

### Synthesis of Potassium 3-(4-methyl-1,4-diazepan-1-yl)prop-1-en-2-yltrifluoroborate

The first step in the production of potassium 3-(4-methyl-1,4-diazepan-1-yl)prop-1-en-2-yltrifluoroborate involves a halogen metal exchange of 2-bromo-3-(4-methyl-1,4-diazepan-1-yl)prop-1-ene with t-butyllithium, which is illustrated as follows:

In the first step of this method, a reaction flask was charged with ethyl ether (500 mL), 2-bromo-3-(4-methyl-1,4-diazepan-1-yl)prop-1-ene (63.3 g, 273 mmol) and cooled under nitrogen to −90° C. Then, t-butyllithium (321 mL, 1.7M in pentane, 546 mmol) was added, keeping the temperature below −80° C. The reaction was allowed to continue to stir at a temperature below −80° C. for 1 h.

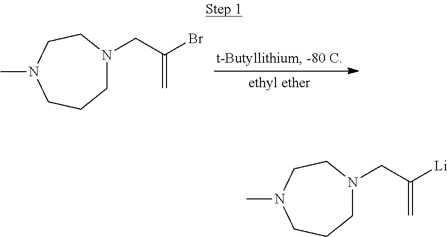

In the second step of the synthesis procedure, 2-isopropoxy-4,4,5,5-tetramethyl-1,3,2-dioxaborolane was added as an electrophile, followed by the addition of potassium hydrogenfluoride in the third step. The reaction scheme can be depicted as follows:

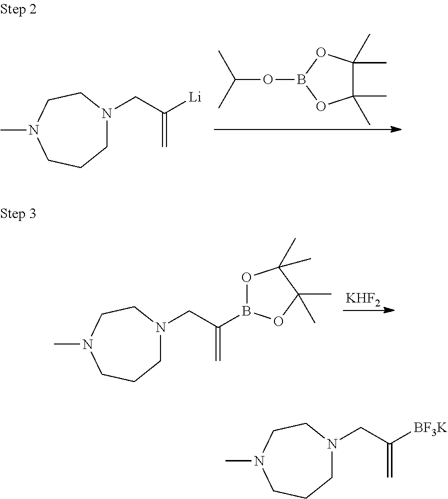

2-isopropoxy-4,4,5,5-tetramethyl-1,3,2-dioxaborolane (50.7 g, 273 mmol) was added keeping the temperature of the reaction below −80° C. The reaction was allowed to stir at this temperature for 4 h and then gradually allowed to warm to room temperature (˜20° C.).

In the third step, the reaction was cooled to 0-10° C. A solution of potassium hydrogenfluoride (74.6 g, 955 mmol) in water (400 mL) was added to the reaction mixture in a slow stream. The resulting reaction mixture was allowed to stir at room temperature for 4 h. The aqueous layer was collected and washed with ethyl ether (300 mL). Then the aqueous layer was concentrated on a rotary evaporator to remove all the volatiles. The resulting residue was dried under high vacuum for 16 h. The resulting residue was then stirred vigorously in refluxing acetonitrile for 2 h and filtered. The filtrate was concentrated on a rotary evaporator and the residue obtained was stirred vigorously in ethyl ether (1000 mL) at room temperature for 6 h and then left in the fridge for 16 h. The solids were filtered, then rinsed with ethyl ether and dried under high vacuum to obtain the product as a white solid. This procedure produced 25 g of product which represents a yield of 35%.

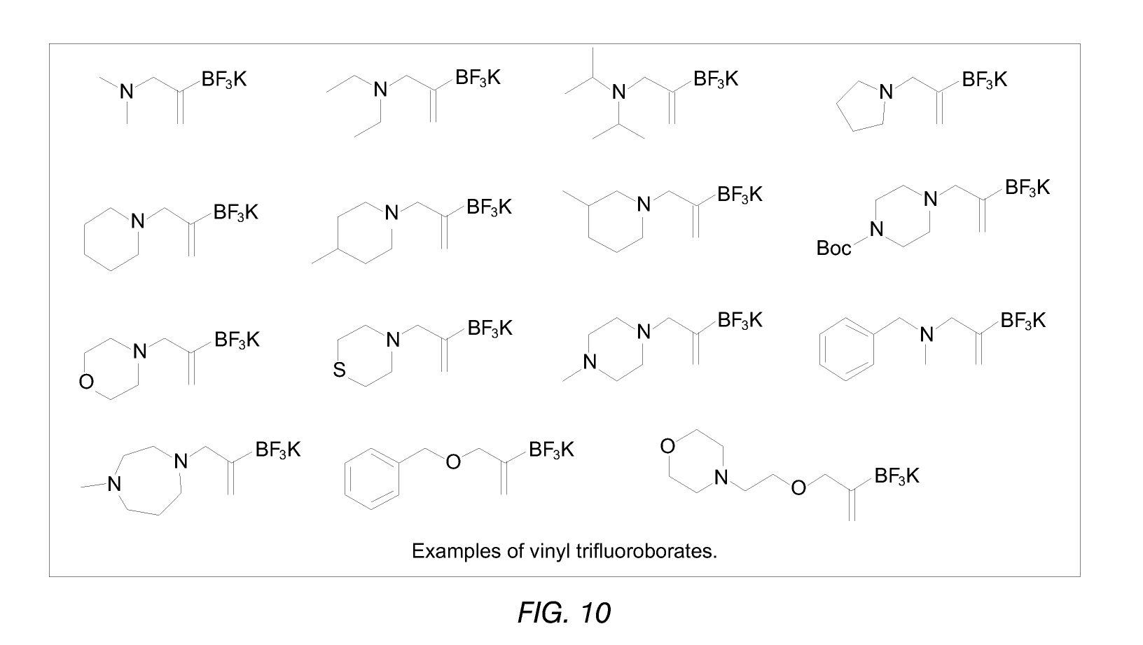

Based on the above methodology, the potassium vinyl-trifluoroborates represented in FIG. 10 have been prepared.

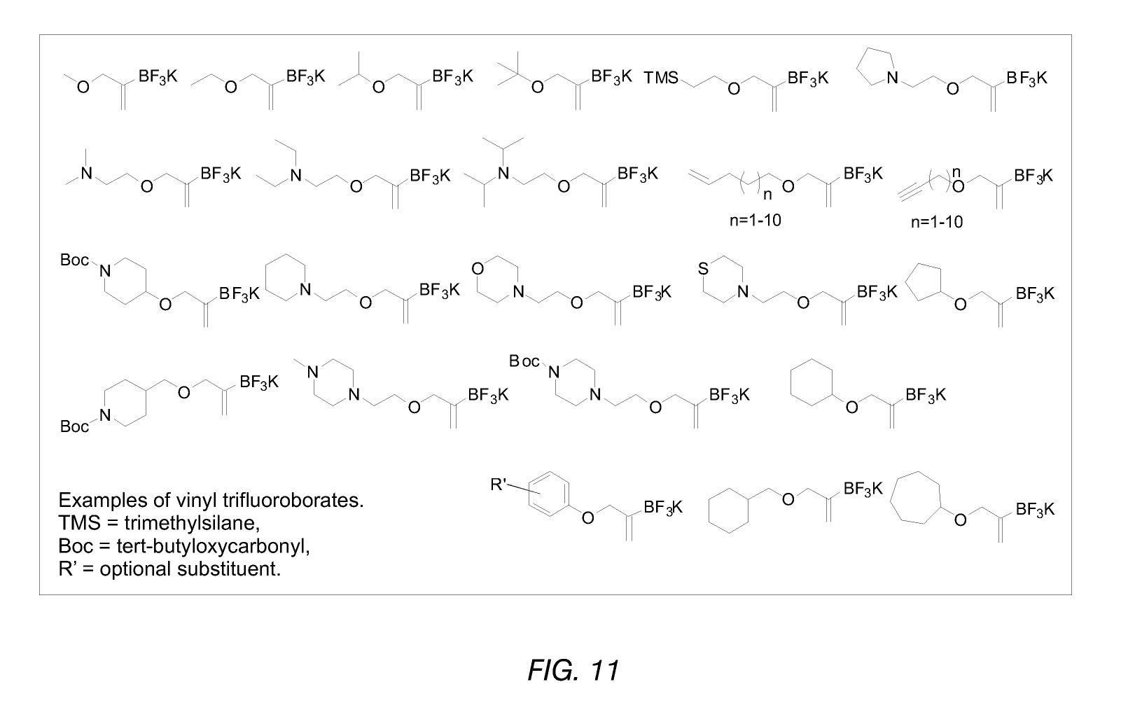

Additional vinyl-boronates represented in the FIG. 11 can be prepared according to the methods and examples disclosed above starting with allyl ether vinyl-bromides.

What is claimed is:

1. A compound having the formula (I): 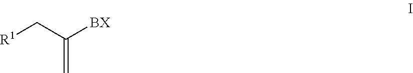
wherein:
R¹ is R^{1a}O—, R^{1a}S—, R^{1b}R^{1c}N—, or R^{1d};
R^{1a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};
R^{1aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;
each R^{2a} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};
each R^{2aa} is separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;
R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc}, said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃, 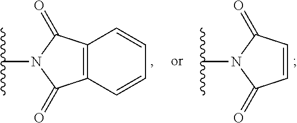
each R^{1bb} is separately hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;
each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, aryl C(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
R^{1d} is C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};
each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and
BX is —BF₃M¹; and M¹ is a metal or metal salt.

2. The compound of claim 1, wherein M¹ is Na⁺, K⁺, Li⁺, ⁺MgX¹, ⁺ZnX¹, or ⁺CuLi; and X¹ is halo.

3. The compound of claim 2, wherein M¹ is K⁺, Li⁺, or ⁺MgX¹.

4. The compound of claim 3, wherein M¹ is K⁺.

5. The compound of claim 1, wherein R¹ is R^{1a}O—, R^{1a}S—, or R^{1b}R^{1c}N—.

6. The compound of claim 5, wherein R¹ is R^{1a}O— or R^{1a}S—.

7. The compound of claim 6, wherein R^{1a} is C₁₋₆ alkyl, C₁₋₆ heteroalkyl, C₃₋₇ cycloalkyl, C₃₋₇ cycloalkenyl, C₂₋₆ alkenyl, C₂₋₆ alkynyl, aryl, heteroaryl, C₇₋₁₃ aralkyl, C₄₋₁₃ heteroaralkyl, or R^{1aa}, each optionally substituted with one or more R^{2a};
R^{1aa} is acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, tert-butyldimethylsilyl, triethylsilyl, 2-trimethylsilylethyl, 2-(trimethylsilyl)ethoxymethyl, triisopropylsilyl, tert-butyl diphenylsilyl, or tert-butyldimethylsilyloxymethyl;
each R^{2a} is separately selected from the group consisting of C₁₋₆ alkyl, C₃₋₇ cycloalkyl, C₃₋₇ cycloalkenyl, C₂₋₆ alkenyl, C₂₋₆ alkynyl, aryl, heteroaryl, C₇₋₁₃ aralkyl, C₄₋₁₃ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, heterocycle, alkoxy, aryloxy, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa}; and
each R^{2aa} is separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, and p-methoxybenzyl.

8. The compound of claim 5, wherein R¹ is R^{1b}R^{1c}N—.

9. The compound of claim 8, wherein R^{1b} and R^{1c} are each independently C₁₋₆ alkyl, C₁₋₆ heteroalkyl, C₃₋₇ cycloalkyl, C₃₋₇ cycloalkenyl, C₂₋₆ alkenyl, C₂₋₆ alkynyl, aryl, heteroaryl, C₇₋₁₃ aralkyl, C₄₋₁₃ heteroaralkyl, or R^{1bb}, each optionally substituted with one or more R^{2bc};
each R^{1bb} is separately acetyl, trifluoroacetyl, formyl, benzoyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl; and
each R^{2bc} is separately selected from the group consisting of C₁₋₆ alkyl, aryl, heteroaryl, C₇₋₁₃ aralkyl, C₄₋₁₃ heteroaralkyl, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, heteroaryl, heterocycle, alkoxy, aryloxy, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino.

10. The compound of claim 8, wherein R^{1b}R^{1c}N— is a non-aromatic heterocycle optionally substituted with one or more R^{2bc}, said non-aromatic heterocycle covalently bonded to the parent molecule through a —N— linkage; and
each R^{2bc} is separately selected from the group consisting of C₁₋₆ alkyl, arylalkylOC(═O)—, C₁₋₆ alkylOC(═O)—, cycloalkylC(═O)—, arylC(═O)—, oxo, and amino.

11. The compound of claim 8, wherein R^{1b}R^{1c}N— is —N₃,

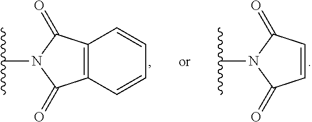

12. The compound of claim 1 having the formula: 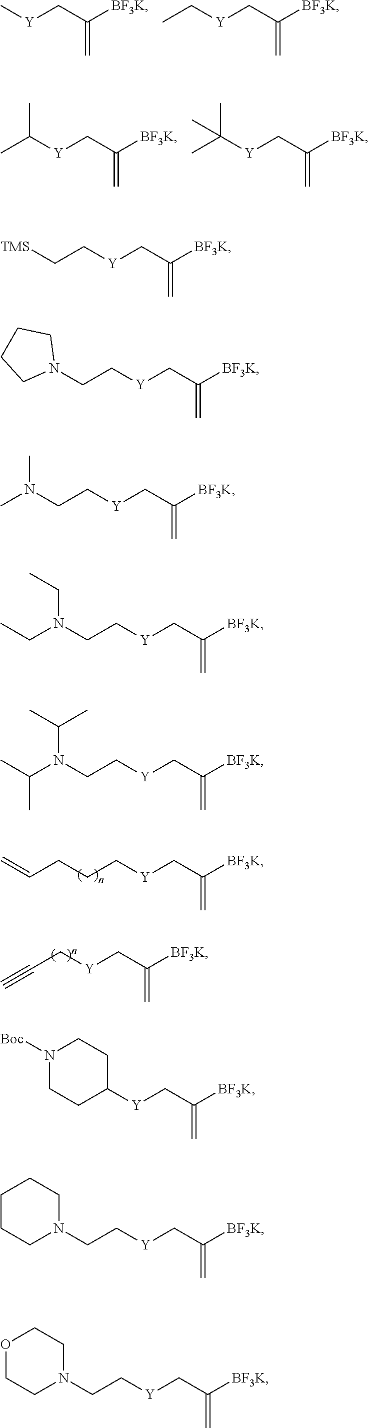 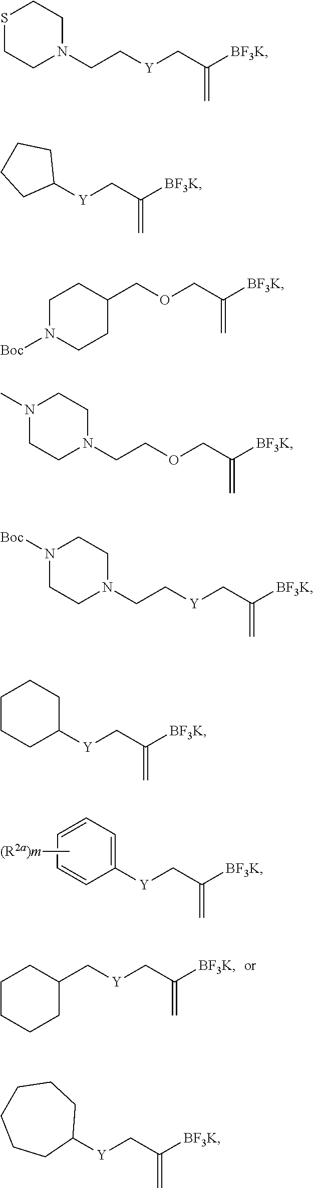
wherein:
Y is oxygen (O) or sulfur (S);
m is an interger from 1-5;
n is an interger from 1-10; and
each R^{2a} is separately selected from the group consisting of C₁₋₆ alkyl, hydroxy, C₁₋₆ alkoxy, cyano, halo, isocyanato, thiocyanato, isothiocyanato, nitro, and amino.

13. The compound of claim 1 having the formula: 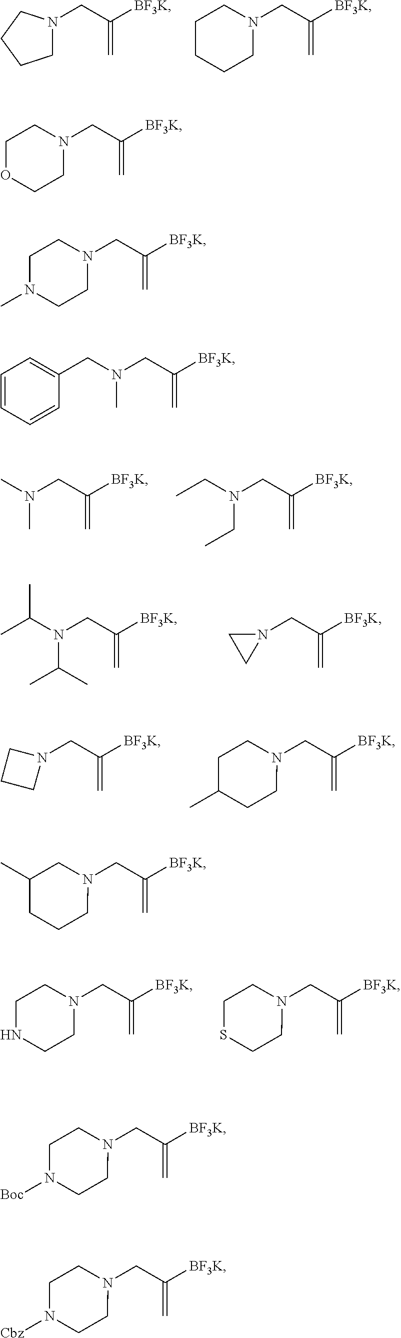 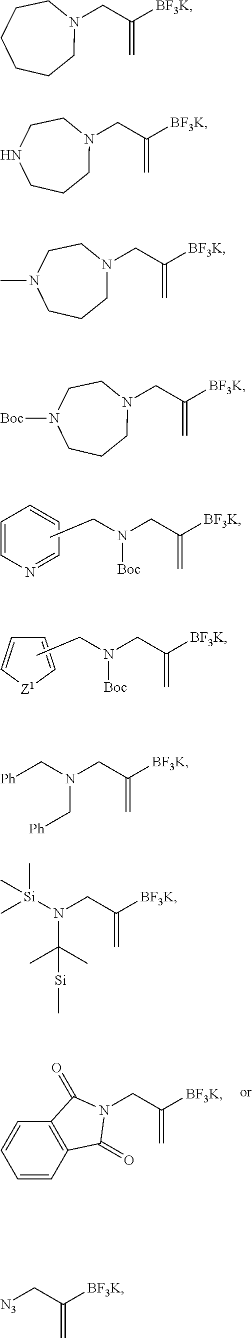
wherein:
Z¹ is oxygen (O), sulfur (S), or NR²⁵; and
R²⁵ is hydrogen (H) or C₁₋₆ alkyl.

14. A compound having the formula (I): 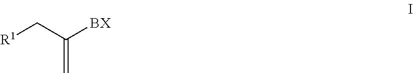
wherein:
R^{1a} is R^{1a}O—, R^{1a}S—, R^{1b}R^{1c}N—, or R^{1d};
R^{1a} is hydrogen (H), C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};
R^{1aa} is —N₃, acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;
each R^{2a} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};
each R^{2aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;
R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc} said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃, 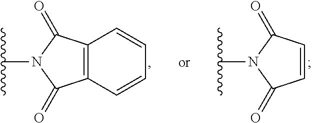
R^{1bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;
each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₁₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
R^{1d} is C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};
each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and
BX is —B(OH)₂, —B(OC₁₋₆ alkyl)₃M¹, or —B(OH)₃M¹; and M¹ is a metal or metal salt.

15. The compound of claim 14, wherein M¹ is Na⁺, K⁺, Li⁺, ⁺MgX¹, ⁺ZnX¹, or ⁺CuLi; and X¹ is halo.

16. The compound of claim 15, wherein R¹ is R^{1a}O—, R^{1a}S—, or R^{1b}R^{1c}N—.

17. A compound having the formula (I): 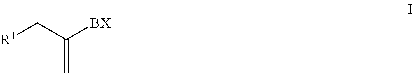
wherein:
R¹ is R^{1a}O—, R^{1a}S—, R^{1b}R^{1c}N—, or R^{1d};
R^{1a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1aa}, each optionally substituted with one or more R^{2a};
R^{1aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;
each R^{2a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{2aa};
each R^{2aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;
R^{1b} and R^{1c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{1bb}, each optionally substituted with one or more R^{2bc}, or R^{1b}R^{1c}N— is a non-aromatic heterocycle optionally substituted with one or more R^{2bc} said non-aromatic heterocycle covalently bonded to the parent molecule through a —N— linkage, or R^{1b}R^{1c}N— is a C₁-C₂₀ alkylideneamino optionally substituted with one or more R^{2bc}, said C₁-C₂₀ alkylideneamino covalently bonded to the parent molecule through a —N— linkage, or R^{1b}R^{1c}N— is —N₃, 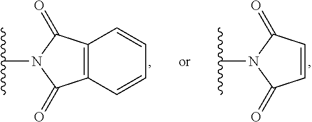
R^{1bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;
each R^{2bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, aryl C(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
R^{1d} is C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{2d};
each R^{2d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino; and
BX is a boronic ester, with the proviso the compound having the formula (I) is not

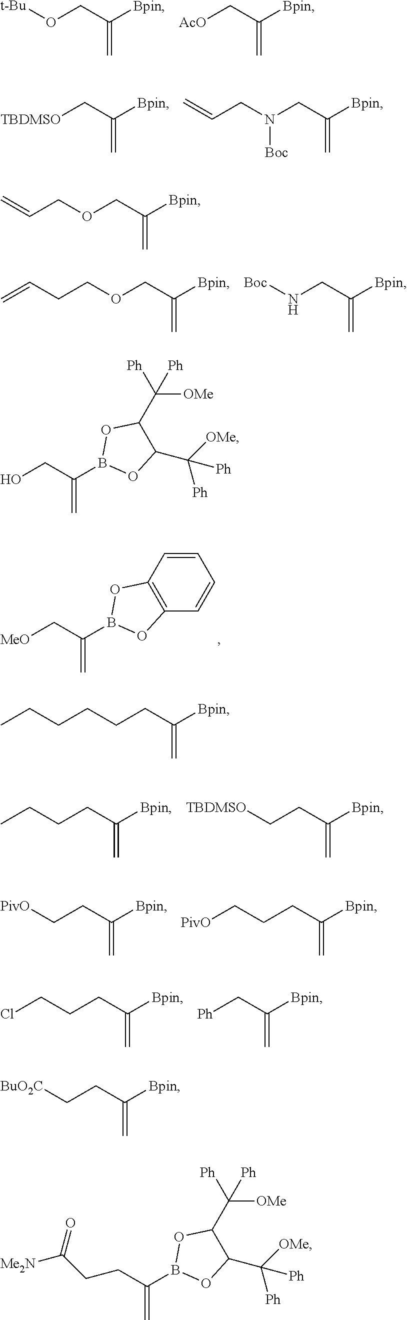

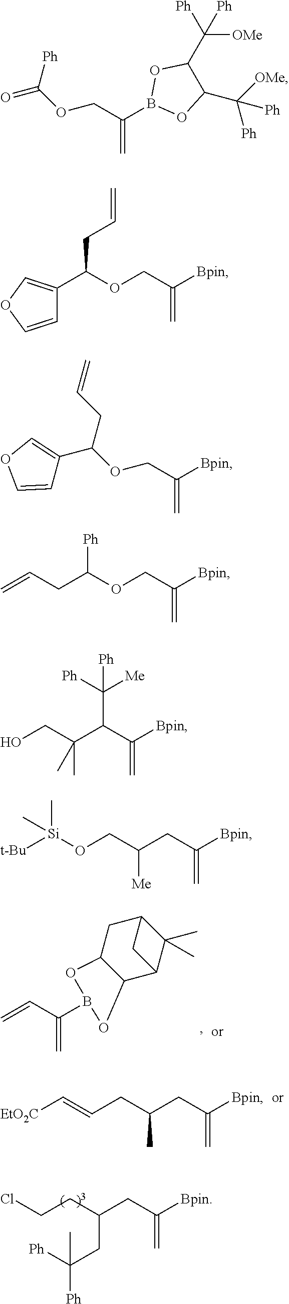

18. The compound of claim 17, wherein BX is a boronic ester having the structure of: 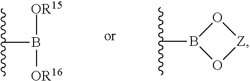
wherein:
R¹⁵ is aryl, or C₁₋₆ alkyl, each optionally substituted with one or more R^{15a};
each R^{15a} is separately halo, or C₁₋₆alkoxy optionally substituted with up to 9 halo;
R¹⁶ is aryl, or C₁₋₆ alkyl, each optionally substituted with one or more R^{16a};
each R^{16a} is separately halo, or C₁₋₆alkoxy optionally substituted with up to 9 halo;
Z is —[C(R³)₂]ₜ—, each C(R³)₂ separately selected and optionally substituted with one or more halo;
t is 1, 2, 3 or 4; and
each R³ is separately H (hydrogen), C₁₋₆ alkyl or C₁₋₆alkoxy optionally substituted with up to 9 halo.

19. A method of chemical synthesis comprising:
reacting a compound of formula (III): 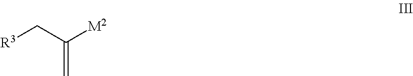
with an alkylborate to provide a compound of formula (IV): 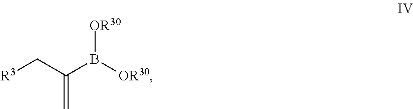
wherein
R³ is R^{30a}O—, R^{30a}S—, R^{30b}R^{30c}N—, or R^{30d};
R^{30a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30aa}, each optionally substituted with one or more R^{40a};
R^{30aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;
each R^{40a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{40aa};
each R^{40aa} is separately selected from the group consisting of C₁₋₆ alkyl, acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;
R^{30b} and R^{30c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30bb}, each optionally substituted with one or more R^{40bc}, or R³⁰R^{30c}N— is a non-aromatic heterocycle optionally substituted with one or more R^{40bc} said non-aromatic heterocycle covalently bonded to the parent molecule through a —N— linkage, or R^{30b}R^{30c}N— is a C₁-C₂₀ alkylideneamino optionally substituted with one or more R^{40bc}, said C₁-C₂₀ alkylideneamino covalently bonded to the parent molecule through a —N— linkage, or R^{30b}R^{30c}N— is —N₃, 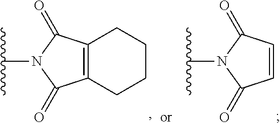
R^{30bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;
each R^{40bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
R^{30d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{40d};
each R^{40d} is separately selected from the group consisting of C₁₋₂₀ alkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
M² is ⁺Li, ⁺ZnX², ⁺MgX², or ⁺CuLi;
X² is halo; and
each R³⁰ is separately C₁₋₂₀ alkyl or C₃₋₁₀ cycloalkyl, or —B(OR³⁰)₂ is

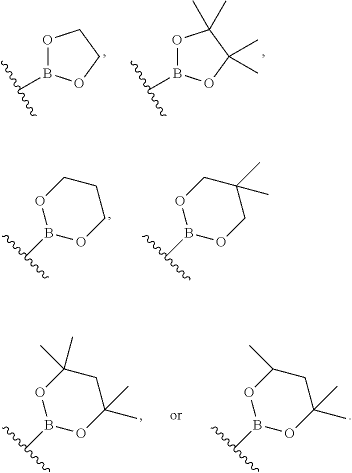

20. The method of claim 19, wherein the alkylborate is

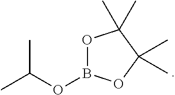

21. A method of chemical synthesis comprising:
reacting a compound of formula (IV): 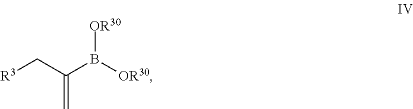
with a bifluoride to provide a compound of formula (V): 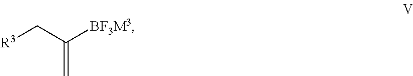
wherein
R³ is R^{30a}O—, R^{30a}S—, R^{30b}R^{30c}N—, or R^{30d};
R^{30a} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30aa}, each optionally substituted with one or more R^{40a};
R^{30aa} is hydrogen (H), acetyl, allyl, benzoyl, benzyl, 2-methoxyethoxymethyl, dimethoxytrityl, methoxytrityl, p-methoxybenzyl, (methylsulfanyl)methyl, pivaloyl, tetrahydropyranyl, trityl, 2-ethoxyethyl, trimethylsilyl, tert-butyldimethylsilyl, triethylsilyl, trimethylsilyl, 2-trimethylsilylethyl, 2-(trimethylsilyl)ethoxymethyl, triisopropylsilyl, tert-butyl diphenylsilyl, or tert-butyldimethylsilyloxymethyl;
each R^{40a} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)ₒ₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino, said heterocycle optionally substituted with one or more R^{40a};
each R^{40aa} is separately selected from the group consisting of acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, and tert-butyldimethylsilyloxymethyl;
R^{30b} and R^{30c} are each independently C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, or R^{30bb}, each optionally substituted with one or more R^{40bc}, or R³⁰R^{30c}N— is a non-aromatic heterocycle optionally substituted with one or more R^{40bc} said non-aromatic heterocycle covalently bonded to the parent molecule through a —N— linkage, or R^{30b}R^{30c}N— is a C₁-C₂₀ alkylideneamino optionally substituted with one or more R^{40bc}, said C₁-C₂₀ alkylideneamino covalently bonded to the parent molecule through a —N— linkage, or R^{30b}R^{30c}N— is —N₃, 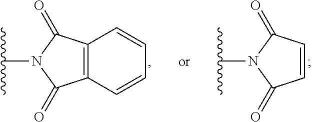
R^{30bb} is hydrogen (H), acetyl, trifluoroacetyl, formyl, benzoyl, allyl, benzyl, 3,4-dimethoxybenzyl, benzyloxylcarbonyl, p-methoxybenzyloxycarbonyl, tert-butyloxycarbonyl, 9-fluorenylmethyloxycarbonyl, allyloxycarbonyl, p-methoxyphenyl, p-toluenesulfonyl, trifluoromethanesulfonyl, 2-trimethylsilylethanesulfonyl, 4-nitrobenzenesulfonyl, tert-butylsulfonyl, 2-methoxyethoxymethyl, dimethoxytrityl, methoxytrityl, p-methoxybenzyl, 2-trimethylsilylethoxylcarbonyl, tert-butyldimethylsilyl, trimethylsilyl, triethylsilyl, triisopropylsilyl, tert-butyldiphenylsilyl, or tert-butyldimethylsilyloxymethyl;
each R^{40bc} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylOC(═O)—, C₁₋₆ alkylOC(═O)—, arylalkylNH—, C₁₋₆ alkylOC(═O)—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
R^{30d} is C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, C₁₋₂₀ alkylthio, or arylthio, each optionally substituted with one or more R^{40d};
each R^{40d} is separately selected from the group consisting of C₁₋₂₀ alkyl, C₁₋₂₀ heteroalkyl, C₃₋₁₀ cycloalkyl, C₃₋₁₀ cycloalkenyl, C₂₋₂₀ alkenyl, C₂₋₂₀ alkynyl, aryl, heteroaryl, C₇₋₂₀ aralkyl, C₄₋₂₀ heteroaralkyl, alkenylO—, arylalkylO—, arylalkylNH—, alkenylO—, cycloalkylC(═O)—, arylC(═O)—, arylC(═O)NH—, arylNHC(═O)—, aryl(CH₂)₀₋₃O(CH₂)₀₋₃—, HO(CH₂)₁₋₃NH—, HO(CH₂)₁₋₃O—, HO(CH₂)₁₋₃—, HO(CH₂)₁₋₃O(CH₂)₁₋₃—, heteroaryl, heterocycle, hydroxy, alkoxy, aryloxy, mercapto, alkylthio, arylthio, cyano, halo, oxo, thiocarbonyl, O-carbamyl, N-carbamyl, O-thiocarbamyl, N-thiocarbamyl, C-amido, N-amido, S-sulfonamido, N-sulfonamido, C-carboxy, O-carboxy, isocyanato, thiocyanato, isothiocyanato, nitro, and amino;
M³ is Na⁺, K⁺, Li⁺, ⁺MgX³, ⁺ZnX³, or ⁺CuLi;
X³ is halo; and
each R³⁰ is separately C₁₋₂₀ alkyl or C₃₋₁₀ cycloalkyl, or —B(OR³⁰)₂ is

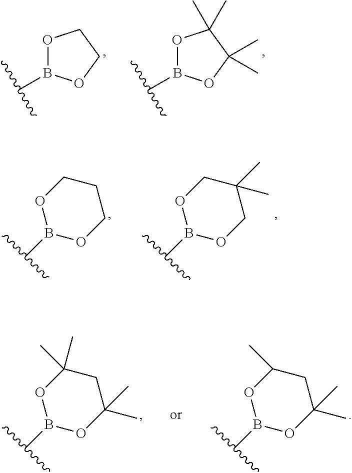

22. The method of claim 21, wherein the bifluoride is K⁺ HF₂⁻.
